(19) United States
(12) Patent Application Publication
(10) Pub. No.: US 2015/0347224 A1
(43) Pub. Date: Dec. 3, 2015

(54) STORAGE CONTROL APPARATUS AND METHOD THEREFOR

(71) Applicant: FUJITSU LIMITED, Kawasaki-shi (JP)

(72) Inventors: Marie Abe, Kawasaki (JP); Koutarou Nimura, Kawasaki (JP); Yoshihito Konta, Kawasaki (JP); Masatoshi Nakamura, Machida (JP)

(21) Appl. No.: 14/698,875

(22) Filed: Apr. 29, 2015

(30) Foreign Application Priority Data
May 29, 2014 (JP) 2014-111500

(51) Int. Cl. G06F 11/10; G06F 11/14; G06F 11/20

(52) U.S. Cl. CPC G06F 11/108; G06F 11/2058; G06F 11/1016; G06F 11/1464; G06F 2201/84

(57) ABSTRACT

In response to a write request for write data, a write control unit writes the write data to a first memory device with the addition of an additional data piece to be updated with each write to the same storage area while writing the additional data piece, within a second memory device, to a storage area corresponding to the write data. In response to a read request for read request, a read control unit reads the read data and an additional data piece added to the read data from the first memory device while reading an additional data piece, within the second memory device, from a storage area corresponding to the read data, and determines validity of the read data based on a checked result obtained by checking the additional data pieces individually read from the first and the second memory devices.

### CROSS-REFERENCE TO RELATED APPLICATION

This application is based upon and claims the benefit of priority of the prior Japanese Patent Application No. 2014-111500, filed on May 29, 2014, the entire contents of which are incorporated herein by reference.

### FIELD

The embodiments discussed herein are related to a storage control apparatus and a storage control method.

### BACKGROUND

As for storage systems, various techniques have been proposed to enhance the reliability of write processing. One example of such is a technique of reading written data immediately after writing the data to a memory device, such as a hard disk drive (HDD), to check if the read data matches the original data. This technique is generally called read-after-write (RAW). In addition, to enhance the reliability of file management, a proposed technique is to examine block corruption in a file by comparing the position of a reference target block against block position information set in a file update information area included in an actually read block.

Japanese Laid-open Patent Publication No. 06-175901

Employing a RAW check enhances the reliability of a data write process in a storage system; however, it involves, in addition to the data write process, a data read process to check the written data. Therefore, in the case of employing the RAW check, a response to a request for the write process is delayed by the time spent on the data read process.

### SUMMARY

According to one embodiment, there is provided a storage control apparatus including a processor that performs a procedure including writing, in response to a write request for write data, the write data to a first memory device with addition of an additional data piece to be updated with each write to the same storage area while writing the additional data piece, within a second memory device, to a storage area corresponding to the write data, and outputting a completion notice of the writing carried out according to the write request; reading, in response to a read request for read data, the read data and an additional data piece added to the read data from the first memory device while reading an additional data piece, within the second memory device, from a storage area corresponding to the read data; and checking the additional data pieces individually read from the first and the second memory devices and determining validity of the read data based on a checked result.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates a configuration and processing example of a storage system according to a first embodiment;

FIG. 2 illustrates a configuration example of a storage system according to a second embodiment;

FIG. 3 illustrates an example of a hardware configuration of a storage control apparatus;

FIG. 4 illustrates an example of functions of the storage control apparatus;

FIG. 5 illustrates a format example of a sector;

FIG. 6 illustrates an example of a RAID management table;

FIG. 7 illustrates an example of write and read control at RAID 1;

FIG. 8 illustrates the example of write and read control at RAID 1, continuing from FIG. 7;

FIG. 9 illustrates an example of write control at RAID 5;

FIG. 10 illustrates an example of read control at RAID 5;

FIG. 11 illustrates an example of data write control involving parity read control;

FIG. 12 illustrates the example of data write control involving parity read control, continuing from FIG. 11;

FIG. 13 illustrates an example of parity read control at RAID 5;

FIG. 14 illustrates an example of recovery of a HDD belonging to a RAID group with RAID 1;

FIG. 15 illustrates an example of recovery of a HDD belonging to a RAID group with RAID 5;

FIG. 16 illustrates the example of recovery of a HDD belonging to a RAID group with RAID 5, continuing from FIG. 15;

FIG. 17 illustrates the example of recovery of a HDD belonging to a RAID group with RAID 5, continuing from FIG. 16;

FIG. 18 is a flowchart illustrating an example of a write control process;

FIG. 19 is a flowchart illustrating an example of a read control process; and

FIG. 20 is a flowchart illustrating an example of a recovery process.

### DESCRIPTION OF EMBODIMENTS

Several embodiments will be described below with reference to the accompanying drawings, wherein like reference numerals refer to like elements throughout.

### (a) First Embodiment

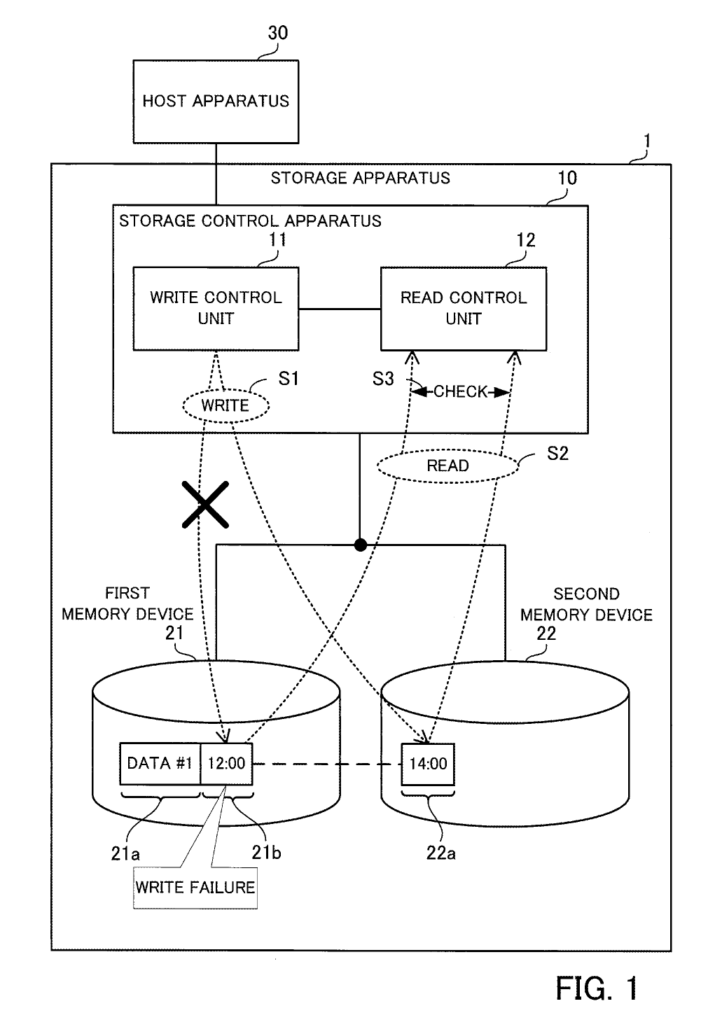

FIG. 1 illustrates a configuration and processing example of a storage system according to a first embodiment. A storage apparatus 1 of the first embodiment includes a storage control apparatus 10, a first memory device 21, and a second memory device 22. The first and second memory devices 21 and 22 are, for example, implemented as a HDD and a solid state drive (SSD). Note that at least one of the first and second memory devices 21 and 22 may be disposed outside the storage apparatus 1. In addition, at least one of the first and second memory devices 21 and 22 may be disposed inside the storage control apparatus 10. To the storage control apparatus 10, a host apparatus 30, for example, is connected. The storage control apparatus 10 writes and reads data to and from the first memory device 21 in response to requests, for example, from the host apparatus 30. The data write and read requests may be issued by, not the host apparatus 30, but an internal function (not illustrated) of the storage control apparatus 10.

The storage control apparatus 10 includes a write control unit 11 and a read control unit 12. In response to a data write request, the write control unit 11 writes, to the first memory device 21, data requested to be written with the addition of an additional data piece. At the same time, the write control unit 11 also writes the write data and the additional data piece, within the second memory device 22, to a storage area corresponding to the write data. After carrying out the above-described processing, the write control unit 11 outputs, to the requestor, completion notification for giving notice of the completion of the write process executed according to the write request. The additional data piece added to the write data only needs to be data updated with each write to the same storage area. Information indicating a data update time, for example, is used as such an additional data piece. In addition, in the first memory device 21, the additional data piece is written to a storage area adjacent to its associated write data.

In response to a data read request, the read control unit 12 reads, from the first memory device 21, read data requested to be read and an additional data piece added to the read data. At the same time, the read control unit 12 reads an additional data piece, within the second memory device 22, from a storage area corresponding to the read data. The read control unit 12 checks the additional data pieces read from each of the first and second memory devices 21 and 22, and determines the validity of the data read from the first memory device 21 based on the checked result. When the additional data pieces agree with each other, the read control unit 12 determines that the read data is valid. On the other hand, when the additional data pieces disagree with one another, the read control unit 12 determines that there is a possibility of the read data being invalid.

Next described is an example of a process starting from an initial state where Data #1 is stored in a data area 21a of the first memory device 21 and an additional data piece associated with Data #1 is stored in an additional data area 21b adjacent to the data area 21a. Assume that the additional data piece indicates the last data update time of the corresponding data area. Assume also that, in the initial state, time “12:00” is stored in the additional data area 21b as an additional data piece associated with Data #1. Note that, in the initial state, the time “12:00” is also stored, within the second memory device 22, in an additional data area 22a corresponding to the data area 21a as an additional data piece associated with Data #1 (not illustrated).

The write control unit 11 receives a write request for writing new Data #2 (not illustrated) to the data area 21a. In response, the write control unit 11 writes Data #2 to the data area 21a, and also writes the current time “14:00” to the additional data area 21b. At the same time, the write control unit 11 also writes the current time “14:00”, within the second memory device 22, to the additional data area 22a corresponding to the data area 21a as an additional data piece (S1).

Assume here that the write process to the data area 21a and the additional data area 21b in the first memory device 21 has been unsuccessful and no updates have taken place in the data area 21a and the additional data area 21b. For example, in the case of the first memory device 21 being a HDD, a “write failure” with no updates taking place in the data area 21a and the additional data area 21b may occur resulting from dust or particles temporarily sticking to the recording surface of the magnetic disk or the head of the HDD.

After this, the read control unit 12 receives a read request for reading data from the data area 21a in the first memory device 21. In response, the read control unit 12 reads the data and the additional data piece from the data area 21a and the additional data area 21b, respectively, of the first memory device 21. At the same time, the read control unit 12 also reads the additional data piece from the additional data area 22a of the second memory device 22 (S2). The read control unit 12 checks the additional data pieces each read from the additional data areas 21b and 22a (S3). If the additional data pieces agree with each other, the read control unit 12 determines that the latest write process to the data area 21a (i.e., the write process of Data #2) was normally executed and the data read from the data area 21a is valid. In this case, the data read from the data area 21a is Data #2.

However, as described above, when the process of writing Data #2 to the data area 21a was not executed normally and, therefore, no updates took place in the data area 21a and the additional data area 21b, the additional data pieces each read from the additional data areas 21b and 22a do not agree with each other. According to the example of FIG. 1, the time “12:00” is read from the additional data area 21b and the time “14:00” is read from the additional data area 22a. In this case, the read control unit 12 determines that there is a possibility of the data read from the data area 21a being invalid because the latest write process to the data area 21a (the write process of Data #2) was not executed normally.

According to the above-described processing, upon a request for reading data, the storage control apparatus 10 checks an additional data piece added to the data stored in the first memory device 21 and an additional data piece stored in a corresponding storage area within the second memory device 22. Herewith, the storage control apparatus 10 is able to determine whether there is a possibility of the read data being invalid. Therefore, it is possible to enhance the reliability of data writing to the first memory device 21.

In addition, upon a request for writing data, the storage control apparatus 10 adds an additional data piece to the data and then writes the data and the additional data piece to the first memory device 21, and also writes the same additional data piece to a different memory device (the second memory device 22). This allows the storage control apparatus 10 to determine whether there is a possibility of the written data being invalid, not upon reception of a request for writing the data, but upon reception of a request for reading the written data at a later time. Therefore, it is possible to control the delay in the response to the data write request. For example, the speed of the response to the data write request is improved compared, for example, to the case of employing a RAW check that examines the validity of data following reception of a request for writing the data.

### (b) Second Embodiment

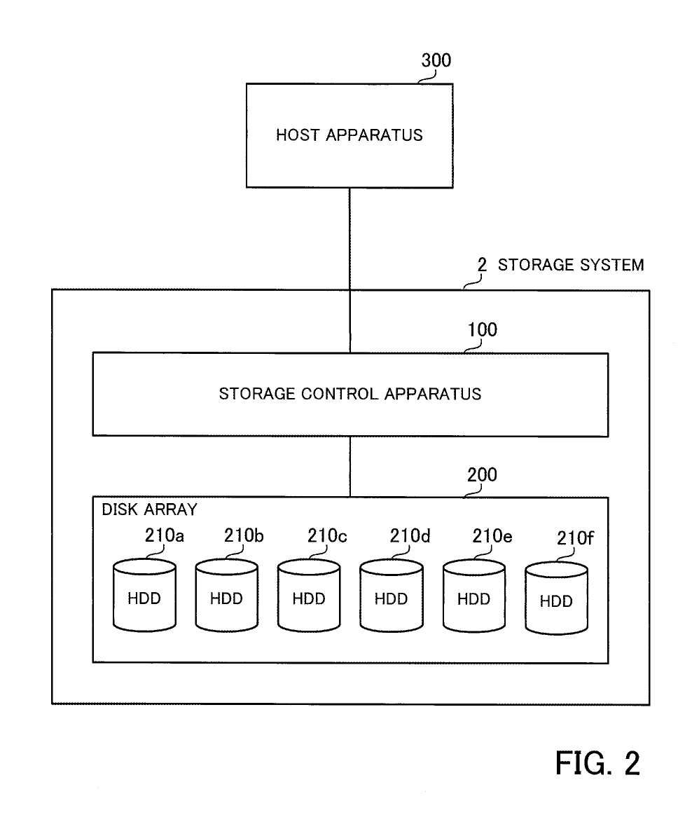

FIG. 2 illustrates a configuration example of a storage system according to a second embodiment. A storage system 2 includes a storage control apparatus 100 and a disk array 200. The storage control apparatus 100 is an example of the storage control apparatus 10 of the first embodiment. The disk array 200 includes HDDs 210a, 210b, 210c, 210d, 210e, and 210f. Each of the HDDs 210a, 210b, 210c, 210d, 210e, and 210f is an example of the first memory device 21 or the second memory device 22 according to the first embodiment. The HDDs 210a, 210b, 210c, 210d, 210e, and 210f store therein data pieces, to each of which access may be requested by a host apparatus 300. In the second embodiment, the HDDs 210a, 210b, 210c, 210d, 210e, and 210f have the same physical storage capacity.

Note that the disk array 200 is provided with HDDs, such as the HDD 210a, as memory devices according to the second embodiment; however, it may include a different type of nonvolatile memory devices other than HDDs, for example, SSDs. In addition, the disk array 200 may include two to five HDDs, or seven or more HDDs. Further, a plurality of disk arrays each having the same configuration as the disk array 200 may be connected to the storage control apparatus 100.

To the storage control apparatus 100, the host apparatus 300 is connected. In response to access requests from the host apparatus 300, the storage control apparatus 100 writes and reads data to and from HDDs within the disk array 200. Such access requests are, for example, “write requests” each requesting for writing data to a HDD of the disk array 200 and “read requests” each requesting for reading data from a HDD of the disk array 200.

In addition, the storage control apparatus 100 manages physical storage areas implemented by the HDDs of the disk array 200 using redundant array of inexpensive disks (RAID) technology to control access to the physical storage areas. In this regard, the storage control apparatus 100 manages a plurality of HDDs installed in the disk array 200 as a RAID group. The RAID group is composed of storage areas of the plurality of HDDs, and is a logical storage area managed in such a manner that data is redundantly stored in different HDDs.

The host apparatus 300 is able to write data to a HDD in the disk array 200 via the storage control apparatus 100, for example, according to a user's operation. In addition, the host apparatus 300 is also able to read data from a HDD in the disk array 200 via the storage control apparatus 100, for example, according to a user's operation.

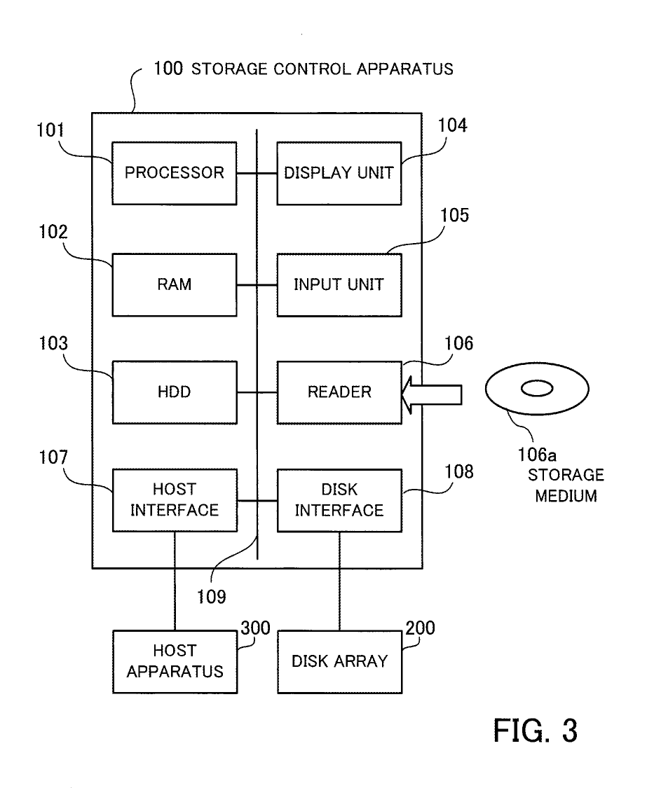

FIG. 3 illustrates an example of a hardware configuration of a storage control apparatus. Overall control of the storage control apparatus 100 is exercised by a processor 101. To the processor 101, a random access memory (RAM) 102 and a plurality of peripherals are connected via a bus 109. The RAM 102 is used as a main memory device of the storage control apparatus 100. The RAM 102 temporarily stores therein at least part of programs to be executed by the processor 101 and various types of data to be used in the processing of the programs.

The peripherals connected to the processor 101 include a HDD 103, a display unit 104, an input unit 105, a reader 106, a host interface 107, and a disk interface 108. The HDD 103 is used as a secondary memory device of the storage control apparatus 100, and stores therein programs to be executed by the processor 101 and various types of data needed for the processor 101 to execute the programs. Note that, as a secondary memory device, a different type of non-volatile memory device such as a SSD may be used in place of the HDD 103. The display unit 104 causes a display provided in the storage control apparatus 100 to display an image according to an instruction from the processor 101. Various types of displays including a liquid crystal display (LCD) and an organic electro-luminescence (OEL) display may be used as the display.

The input unit 105 transmits, to the processor 101, an output signal sent out according to an input operation by a user of the storage control apparatus 100. Examples of the input unit 105 are a touch-pad and a key board. The reader 106 is a drive unit for reading programs and data recorded on a storage medium 106a. Examples of the storage medium 106a include a magnetic disk such as a flexible disk (FD) and a HDD, an optical disk such as a compact disc (CD) and a digital versatile disc (DVD), and a magneto-optical disk (MO). The host interface 107 performs interface processing of transmitting and receiving data between the host apparatus 300 and the storage control apparatus 100. The disk interface 108 performs interface processing of transmitting and receiving data between the disk array 200 and the storage control apparatus 100.

Note that the storage control apparatus 100 may not be provided with the reader 106. Further, in the case where the storage control apparatus 100 is controlled mainly from a different terminal, it may not be provided with the display unit 104 and the input unit 105.

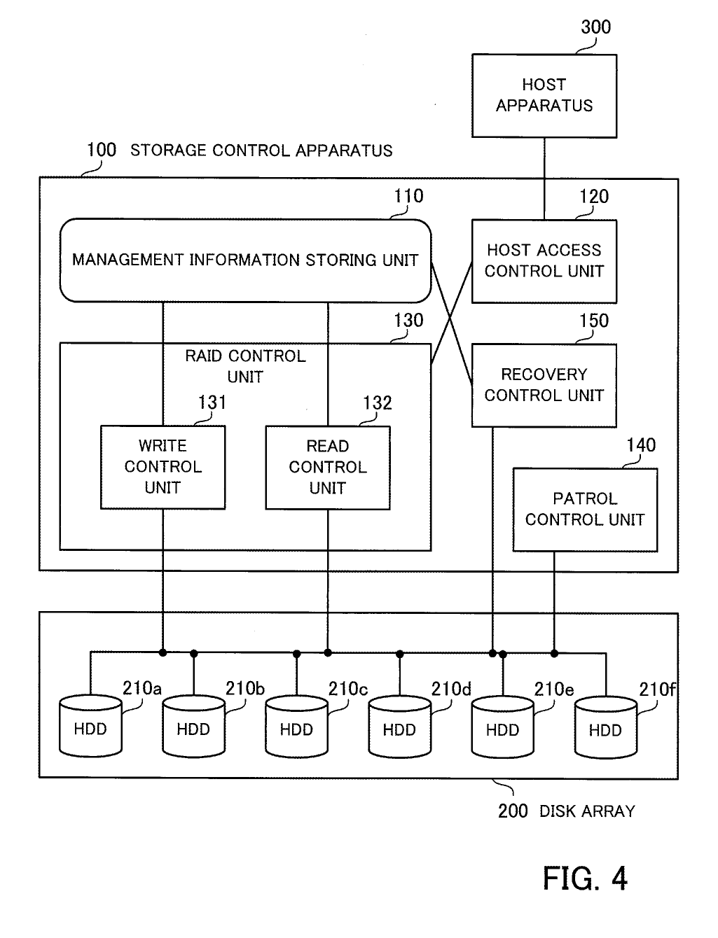

FIG. 4 illustrates an example of functions of a storage control apparatus. The storage control apparatus 100 includes a management information storing unit 110, a host access control unit 120, a RAID control unit 130, a patrol control unit 140, and a recovery control unit 150. The management information storing unit 110 may be implemented as a storage area allocated in the RAM 102 or the HDD 103. Individual processes performed by the host access control unit 120, the RAID control unit 130, the patrol control unit 140, and the recovery control unit 150 are implemented, for example, by the processor 101 executing predetermined programs. The management information storing unit 110 stores therein RAID management tables each storing information on a RAID group managed by the storage control apparatus 100.

The host access control unit 120 receives, from the host apparatus 300, an access request (a read or write request) for a storage area (logical volume) implemented by HDDs in the disk array 200. The host access control unit 120 controls access to the storage area within the disk array 200 from the host apparatus 300 while using a part of the RAM 102 as a cache area. The cache area is a storage area for caching data to be stored in the disk array 200. For example, the host access control unit 120 temporarily accumulates, in the cache area, data requested by the host apparatus 300 to be written. The host access control unit 120 employs a cache writing scheme called “write-back” in which data accumulated in the cache area is stored in the storage area of the disk array 200 asynchronous with a write of the data to the cache area. When write-back is enabled, the host access control unit 120 issues a request to the RAID control unit 130 for a data write to the disk array 200 while designating data to be written back as well as a RAID group and a logical storage area to which the data is to be written.

In addition, upon reception of a data read request from the host apparatus 300, the host access control unit 120 determines whether data requested to be read has been accumulated in the cache area. If the requested data has been accumulated in the cache area, the host access control unit 120 reads the data from the cache area and sends it to the host apparatus 300. On the other hand, if the requested data is not accumulated in the cache area, the host access control unit 120 requests the RAID control unit 130 to read the data while designating a logical address within a logical volume, from which the data is to be read. The host access control unit 120 stores, in the cache area, the data read from the disk array 200 and also transmits the data to the host apparatus 300.

The RAID control unit 130 includes a write control unit 131 and a read control unit 132. The write control unit 131 is an example of the write control unit 11 of the first embodiment. In addition, the read control unit 132 is an example of the read control unit 12 of the first embodiment. Upon reception of a write request from the host access control unit 120, the write control unit 131 identifies a write-to physical storage area based on information of a RAID group corresponding to a write-targeted logical volume and a logical address designated by the host access control unit 120. The information of the corresponding RAID group is stored in a RAID management table. The physical storage area is identified by a disk number and a sector number. The disk number is used to identify a HDD in the disk array 200. The sector number is used to identify a sector in each HDD. The write control unit 131 writes data to the identified HDD physical storage area in the disk array 200.

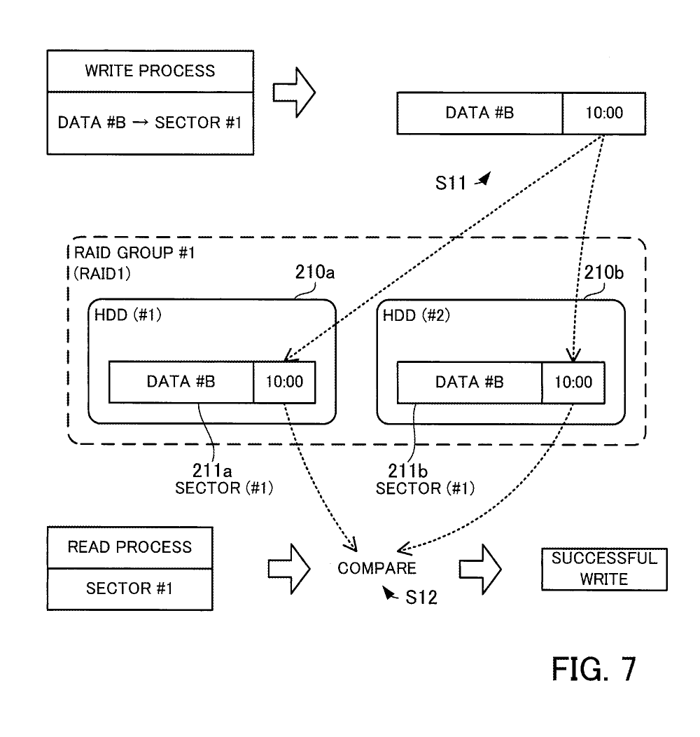

In writing the data, the write control unit 131 generates an “update time information piece” indicating the update time and date of the write-to sector. The write control unit 131 writes the generated update time information piece to the write-to sector together with the data. At the same time, the write control unit 131 writes, as additional information, the generated update time information piece to a sector in a different HDD belonging to the same RAID group as the write-to HDD. The write control unit 131 informs the host access control unit 120 of the data write result. Note that the method for identifying a write-to sector for an update time information piece is described in detail with reference to FIG. 7 and following figures. According to the second embodiment, in the case of writing data to a plurality of different HDDs, it is possible to perform parallel writes to the individual HDDs.

In response to a request from the host access control unit 120, the read control unit 132 reads data from a HDD in the disk array 200. When the requestor is the host access control unit 120, the read control unit 132 identifies a physical storage area from which the data is to be read based on information of a RAID group corresponding to a read-targeted logical volume and a read-from logical address designated by the host access control unit 120. The information of the corresponding RAID group is stored in a RAID management table. The read control unit 132 transfers read data to the requesting function (i.e., the host access control unit 120). According to the second embodiment, in the case of reading data from a plurality of different HDDs, it is possible to perform parallel reads from the individual HDDs.

In reading the data, the read control unit 132 refers to the RAID management table to thereby identify, within a different HDD belonging to the same RAID group as the read-from HDD, a sector storing therein an update time information piece to be used for comparison. The read control unit 132 reads the update time information piece from the identified sector and an update time information piece from the sector of the read-from HDD, and compares these read update time information pieces. When the update time information pieces agree with each other, the read control unit 132 determines that no write failure occurred in the write process to the sector of the read-from HDD. Here, the “write failure” means that, in writing data to a sector, the write to the sector fails due to dust or particles temporarily sticking to the surface of the magnetic disk or the head of the HDD, which results in no data update being made in the sector.

If the update time information pieces do not agree with each other, the read control unit 132 determines that a write failure occurred in the latest write process at one of the sectors storing the compared update time information pieces, and determines a sector with the write failure based on the comparison result. The read control unit 132 requests the recovery control unit 150 for sector recovery while designating the sector determined to have undergone the write failure. If the sector having undergone the write failure is the read-from sector, the read control unit 132 reads the sector and then informs the requesting function of data set in the read sector after receiving notification about completion of the sector recovery from the recovery control unit 150. Here, the “sector recovery” means recovering only a single sector in a HDD.

According to an input operation by an administrator of the storage system 2, or periodically or irregularly, the patrol control unit 140 reads data from sectors of each HDD in the disk array 200 to examine the HDD for abnormalities. If there is a HDD from which data has failed to be read, the patrol control unit 140 informs the administrator of the storage system 2 accordingly. In response to the notice, the administrator sends, for example, an input operation to the storage control apparatus 100 to thereby cause the storage control apparatus 100 to recover the HDD informed by the patrol control unit 140. When there is a HDD from which data has failed to be read, the patrol control unit 140 may request the recovery control unit 150 for HDD recovery while designating the disk number of the HDD with the read failure, or may record the HDD with the read failure, for example, in a log file. In the latter case, the log file is stored, for example, in the HDD 103 of the storage control apparatus 100. Here, the “HDD recovery” means recovering data in each sector of the HDD.

In response to a request from the read control unit 132, the recovery control unit 150 recovers a designated sector. In addition, according to an input operation by the administrator of the storage system 2, the recovery control unit 150 recovers a designated HDD.

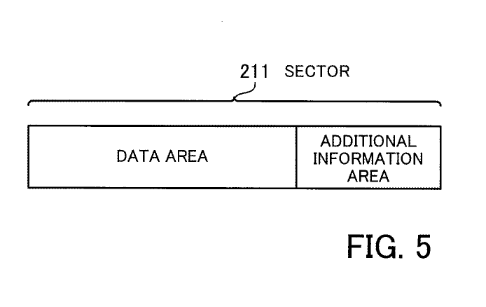

FIG. 5 illustrates a format example of a sector. Assume that the leftmost area in FIG. 5 is the forefront area, i.e., the beginning of the storage area. A sector 211 is an area formed by dividing the physical storage area of each HDD in the disk array 200 into sections with fixed storage capacity. The sector 211 is the smallest unit used when the storage control apparatus 100 records data into the physical storage area of a HDD. For example, the RAID control unit 130 divides data requested by the host access control unit 120 to be written into data segments of fixed data length and writes each data segment to a single sector 211.

The sector 211 includes a data area and an additional information area. Assume, for example, that the size of each sector 211 is 4224 bytes, the size of the data area is 4160 bytes, and the size of the additional information area is 64 bytes. The data area stores therein data requested by the host apparatus 300 to be written or parity information of data distributed across a stripe. The additional information area stores therein information indicating an update time and date (i.e., an update time information piece) of the data in its own sector. In the case where the level of a RAID group to which the sector 211 belongs is RAID 5, the additional information area also stores one or more update time information pieces of other sectors in the same stripe. Note that, within each sector, the additional information area may be located adjacent to and in front of the data area, or adjacent to and at the back of the data area. According to the second embodiment, the additional information area is located at the back of the data area.

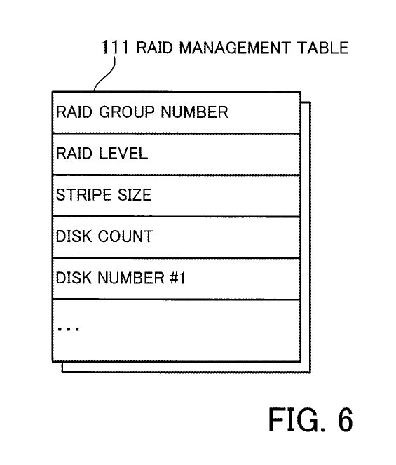

FIG. 6 illustrates an example of a RAID management table. The RAID management table 111 stores therein information on RAID groups managed by the storage control apparatus 100. The RAID management table 111 is generated for each RAID group and then stored in the management information storing unit 110. Each RAID management table 111 includes information corresponding to the following items: RAID group number; RAID level; stripe size; disk count; and disk number.

In the RAID group number item, the identification number of a corresponding RAID group is set. In the RAID level item, the RAID level used to control the corresponding RAID group is set. In the stripe size item, the size of a storage area of one stripe on each memory device is set in the case where the corresponding RAID level is a RAID level employing the technique of striping (for example, RAID 5). In the disk count item, the number of HDDs belonging to the corresponding RAID group is set. In the disk number item, the identification numbers of the HDDs belonging to the corresponding RAID group are set. Therefore, disk numbers as many as the number set in the corresponding disk count item are registered in the disk number item.

Next described is a method used by the RAID control unit 130 to exercise data write and read control over HDDs belonging to a RAID group with RAID level of 1 (RAID 1) and determine whether a data write failure has occurred. In writing data to HDDs in the disk array 200, if the write-to HDDs belong to a RAID group of RAID 1, the write control unit 131 writes the data as well as an update time information piece to a sector in each of the write-to HDDs. Then, the write control unit 131 informs the host access control unit 120 of the write result. Note that because the configuration of the physical storage area is the same across the HDDs in the storage system 2, the write-to sector of each HDD has the same sector number in the case where the write-to HDDs belong to a RAID group with RAID 1.

In reading data from a RAID group of RAID 1, the read control unit 132 reads data and its associated update time information piece from a read-from sector in one HDD. At the same time, the read control unit 132 reads an update time information piece from the same sector in the other HDD. Subsequently, the read control unit 132 compares the read update time information pieces, and determines whether a write failure has occurred in each of the read-from sectors based on the comparison result.

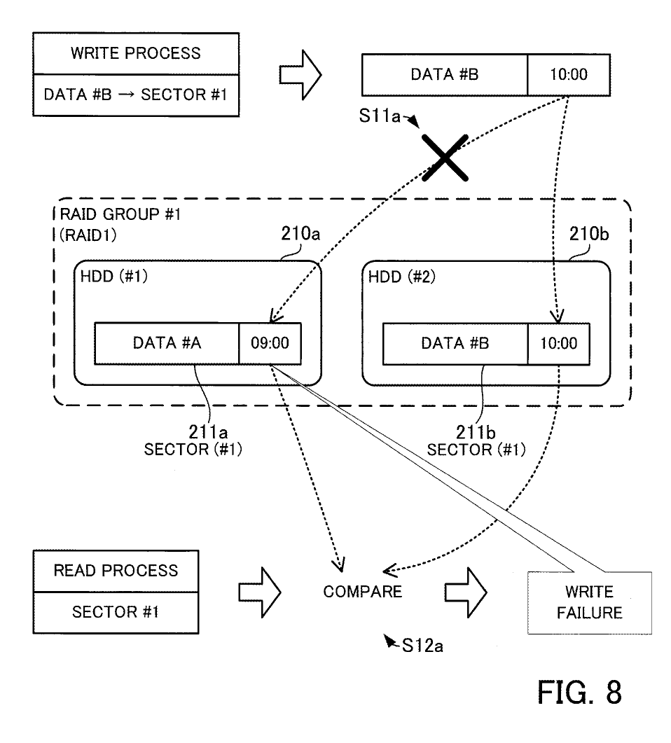

Next described is a specific example of data write and read control in the case of RAID 1, with reference to FIGS. 7 and 8. FIG. 7 illustrates an example of write and read control at RAID 1. The HDDs 210a and 210b belong to RAID Group #1. The RAID level of RAID Group #1 is RAID 1. The disk number of the HDD 210a is “#1” and the disk number of the HDD 210b is “#2”. Sectors 211a and 211b are storage areas in the HDD 210a and 210b, respectively, and both the sectors 211a and 211b have a sector number of “#1”. That is, the sectors 211a and 211b undergo the same data write process. Hereinafter, a HDD with disk number “n” (n is a natural number) is sometimes denoted as “HDD #n”. Similarly, a sector with sector number “n” (n is a natural number) is sometimes denoted as “Sector #n”.

Next described is an exemplary case where no write failure of Data #B occurs when the write control unit 131 executes a process of writing Data #B to Sector #1 in each HDD belonging to RAID Group #1. First, the write control unit 131 generates an update time information piece for each of the sectors 211a and 211b. Then, the write control unit 131 writes the generated update time information piece together with Data #B to both the sectors 211a and 211b (S11). Note that the write control unit 131 is able to perform parallel writes of the data and the update time information piece to the individual sectors 211a and 211b. As illustrated in the upper part of FIG. 7, both the data writes to the sectors 211a and 211b are successful. Therefore, as illustrated in the middle of FIG. 7, Data #B is stored in the data areas of the individual sectors 211a and 211b while update time information “10:00” is stored in their additional information areas as update time information pieces. Thus, when the data writes to the individual sectors are successful, the update time information pieces in the sectors have the same value.

Next, when reading Data #B from Sector #1 of the individual HDDs belonging to RAID Group #1, the read control unit 132 reads Data #B and the update time information piece from the sector 211a of HDD #1, and also reads the update time information piece from the sector 211b of HDD #2. Note that, in actual processing, the same sector number “1” is designated as a read-from address for both HDDs #1 and #2, and all information stored in the individual sectors 211a and 211b is read from HDDs #1 and #2, respectively, according to the designation. The read control unit 132 compares the update time information pieces read from the individual sectors 211a and 211b. As illustrated in the middle of FIG. 7, the update time information pieces of the sectors 211a and 211b agree with each other. Therefore, the read control unit 132 determines that no failure has occurred in writing data to Sector #1 of the individual HDDs.

FIG. 8 illustrates the example of write and read control at RAID 1, continuing from FIG. 7. FIG. 8 represents an exemplary case where a write failure of Data #B occurs when the write control unit 131 executes a process of writing Data #B to Sector #1 in each HDD belonging to RAID Group #1. In FIG. 8, as for the same configurations and processes as in FIG. 7, the descriptions are omitted. Assume in FIG. 8 that, prior to writes to the sectors 211a and 211b, Data #A has been stored in the data areas of both the sectors 211a and 211b and “9:00” has been stored in their additional information areas as the update time information pieces.

First, the write control unit 131 writes, to the sectors 211a and 211b, an update time information piece of each sector together with Data #B (S11a), as in FIG. 7. As illustrated in the upper part of FIG. 8, the data write to the sector 211b is successful; however, the data write to the sector 211a has failed. Therefore, as illustrated in the middle of FIG. 8, within the sector 211a, Data #A, which is previous data before the update, is still stored in the data area, and “09:00”, which is update time information piece associated with the time when the data area was updated with Data #A, is still stored in the additional information area. On the other hand, within the sector 211b, the data area has been updated with Data #B and the additional information area has been updated with the update time information piece “10:00” associated with the time when the data area of the sector 211b was updated with Data #B. Hence, the value indicated by the update time information piece stored in the sector 211a with a write failure is smaller than that of the update time information piece stored in the sector 211b with a successful write.

Thus, if a write failure has occurred in one of the sectors storing the update time information pieces, the update time information pieces do not agree with each other. In addition, an update time information piece has a larger value if the update time indicated by the update time information piece is closer to the latest update time. Therefore, as in the above-described case, the value of an update time information piece stored in a sector with a write failure is smaller than that stored in the other sector with a successful write.

Next, when reading data from Sector #1 of the individual HDDs belonging to RAID Group #1, the read control unit 132 reads the data and the update time information piece from the sector 211a of HDD #1, and also reads the update time information piece from the sector 211b of HDD #2. Then, the read control unit 132 compares the update time information pieces read from the individual sectors 211a and 211b. As illustrated in the middle of FIG. 8, the update time information piece stored in the sector 211a has a smaller value than the update time information piece stored in the sector 211b. Therefore, the read control unit 132 determines that a data write failure has occurred in the sector 211a.

As described in FIGS. 7 and 8, in writing data to a RAID group with RAID 1, an update time information piece is written together with the data to each of both the write-to sectors of the data. In reading data from a RAID group with RAID 1, update time information pieces are read, within two HDDs belonging to the same RAID group, from individual read-from sectors having the same sector number, and the read update time information pieces are compared to thereby determine whether a write failure has occurred.

By writing an update time information piece to a partial area within a write-to sector of write-targeted data associated with the update time information piece, the update time information piece is stored in the same sector together with the associated data. Therefore, determining the update status of the update time information piece allows determining whether a write failure of the data stored in the same sector has occurred, thus enhancing the reliability of data writing.

Unlike a RAW check that determines whether a data write failure has occurred following reception of a data write request, whether a data write failure has occurred is determined upon reception of a data read request. Therefore, the delay in the response to the data write request is controlled compared to the case of employing a RAW check.

Information taking a larger value with a more recent update of the associated data, like the above-described update time information piece, is used as the information stored in the additional information area of each sector. Herewith, it is possible to identify a sector with a write failure by comparing pieces of the information set in the additional information areas of individual sectors.

In addition, writing an update time information piece to a storage area adjacent to each piece of duplicated data allows parallel writes of the update time information pieces to individual HDDs. Furthermore, it is possible to simultaneously write the update time information pieces together with the associated data. Therefore, the process of writing update time information pieces is executed with little effect on the response time for a data write request. Also in a data read process, simultaneous reads of an update time information piece and its associated data is possible from one HDD. Further, storing update time information pieces in different HDDs allows parallel reads of the update time information pieces. Therefore, it is possible to read update time information pieces from a plurality of HDDs without any influence on the response time for a data read request. As a result, whether a write failure has occurred is determined without affecting the response time for an access request from the host apparatus 300.

Note that FIGS. 7 and 8 describe examples of determining whether a write failure has occurred in a sector belonging to a RAID group with RAID 1; however, the RAID level to which the above-described method is applied is not limited to RAID 1 and is applicable to a RAID group with data duplication. For example, in FIGS. 7 and 8, the RAID level of RAID Group #1 may be RAID 1+0 or RAID 0+1.

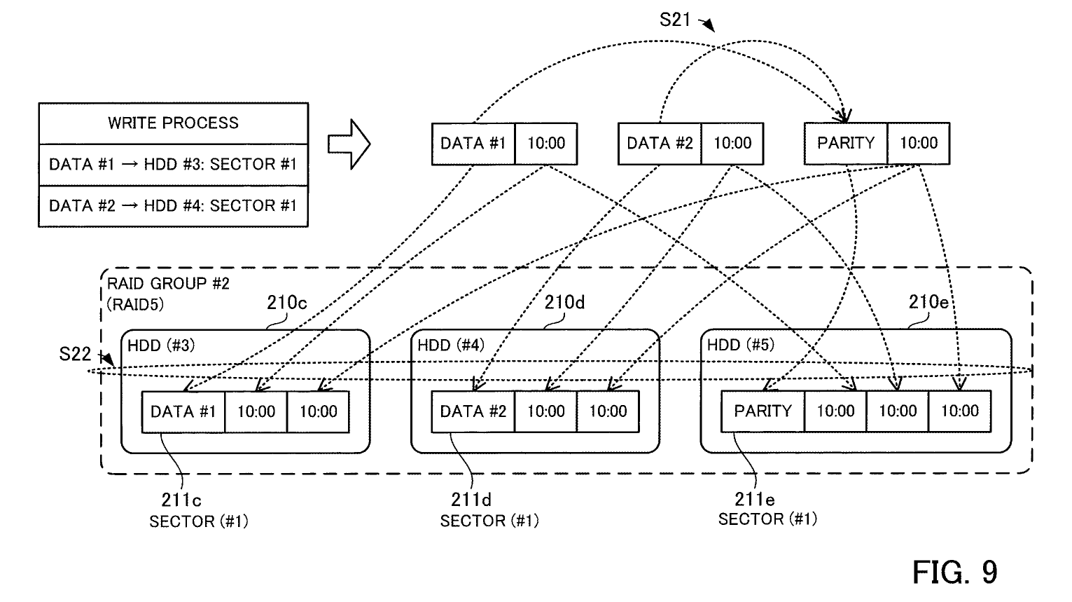

Next described is a case of RAID 5 as an example where data is duplicated redundantly using parity. Note that in the following description, a sector in which data is stored in its data area is sometimes referred to as the “data sector” while a sector in which parity is stored in its data area is sometimes referred to as the “parity sector”. First, write control in a case where a write-to RAID group is configured at RAID level of 5 (RAID 5) and all data sectors in a write-to stripe are updated is described with reference to FIG. 9.

FIG. 9 illustrates an example of write control at RAID 5. The HDDs 210c, 210d, and 210e belong to RAID Group #2. The RAID level of RAID Group #2 is RAID 5. The disk numbers of HDDs 210c, 210d, and 210e are “#3”, “#4”, and “#5”, respectively. Sectors 211c, 211d, and 211e are storage areas provided in the HDDs 210c, 210d, and 210e, respectively, and each of the sectors 211c, 211d, and 211e has a sector number of “#1”. The sectors 211c, 211d, and 211e make up a single stripe. The sectors 211c and 211d are sectors storing therein data (data sectors) while the sector 211e is a sector storing therein parity (parity sector) of the data stored across the sectors 211c and 211d.

In the case where one set of parity is used as in RAID 5, the additional information area of each data sector making up the single stripe stores therein an update time information piece corresponding to the sector and an update time information piece corresponding to the parity sector of the stripe. On the other hand, the additional information area of the parity sector stores therein the update time information pieces corresponding to the individual data sectors of the stripe and the update time information piece corresponding to the parity sector.

Next described is an example of simultaneously writing Data #1 and #2 to Sectors #1 of the HDDs 210c and 210d, respectively, belonging to RAID Group #2. Note that, in FIG. 9 and following figures, a physical storage area with disk number #m (m is a natural number) and sector number #n (n is a natural number) is sometimes denoted as “HDD #m:Sector #n”. In this case, the write control unit 131 first calculates parity using Data #1 and #2 to be written, and generates update time information pieces of the sectors 211c, 211d, and 211e whose data areas are to be updated (S21). At this point, all the update time information pieces of the sectors 211c, 211d, and 211e indicate “10:00”.

Subsequently, the write control unit 131 updates the sector 211c with Data #1 and the update time information piece “10:00”, and also updates the sector 211d with Data #2 and the update time information piece “10:00”. At the same time, the write control unit 131 updates the sector 211e with the calculated parity and the update time information piece “10:00” (S22). In this regard, as for each of the data sectors 211c and 211d, the update time information piece of its own sector is stored in the forefront area within the additional information area (i.e., in FIG. 9, the leftmost area within the additional information area of each of the sectors 211c and 211d). In addition, the update time information piece of the sector 211e is stored in an area subsequent to (i.e., right-hand side of) the forefront area. That is, in the additional information area of each data sector, the update time information piece of its own sector and the update time information piece of the parity sector are arranged in the stated order from the front side of the additional information area.

As for the additional information area of the parity sector 211e, the update time information piece of the sector 211c is set in the forefront area (i.e., in FIG. 9, the leftmost area within the additional information area of the sector 211e). In addition, the update time information piece of the sector 211d is set in an area subsequent to (right-hand side of) the forefront area with the update time information piece of the sector 211c, and the update time information piece of the parity sector 211e is set in an area subsequent to (right-hand side of) the area with the update time information piece of the sector 211d. That is, in the additional information area of the parity sector, the update time information pieces of all the sectors in the stripe are arranged in order of disk numbers corresponding to the sectors from the front side of the additional information area.

Thus, in writing to each data sector in HDDs belonging to a RAID group with RAID 5, the write control unit 131 writes write-targeted data to the data area of the data sector. At the same time, the write control unit 131 writes an update time information piece of the data sector and an update time information piece of an associated parity sector to the additional information area of the data sector. Further, in writing to the parity sector, the write control unit 131 writes calculated parity in the data area, and at the same time, writes the update time information pieces of all the data sectors and the update time information piece of the parity sector to the additional information area.

Note that according to the second embodiment, each data sector stores therein an update time information piece of itself and an update time information piece of an associated parity sector, and the parity sector stores therein update time information pieces of all sectors belonging to the same stripe. Alternatively, each sector making up a stripe may store an update time information piece of itself and an update time information piece of a sector belonging to a HDD with a disk number following the disk number of its own HDD. This is applicable to any RAID group where a plurality of HDDs belonging to the RAID group are striped together, and a RAID group with RAID 0 is an example of such.

The sequence of update time information pieces stored in the additional information area of each sector is not limited to the above-described manner. For example, in the additional information area of each data sector, update time information pieces of individual sectors making up the same stripe may be arranged in order of disk numbers of HDDs to which the individual sectors belong. Alternatively, within the additional information area of an associated parity sector, update time information pieces of data sectors are placed in the front side of the additional information area while being arranged in order of disk numbers of HDDs to which the data sectors belong, and an update time information piece of the parity sector is then placed in the subsequent area.

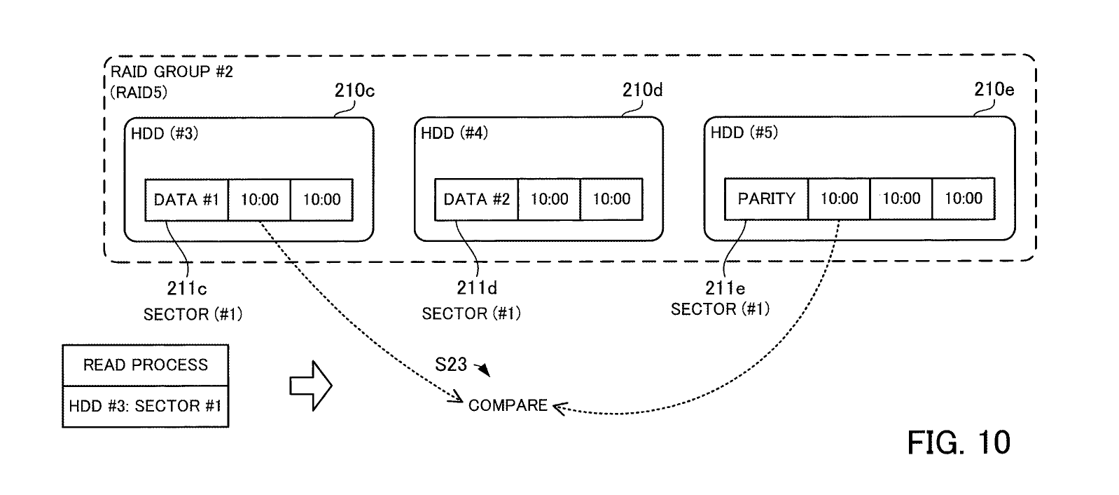

Next described is data read control exercised by the RAID control 130 on a RAID group with RAID 5, with reference to FIG. 10. The read control unit 132 reads, from a data sector storing data requested by a requestor and a parity sector belonging to the same stripe as the data sector, update time information pieces corresponding to the data sector. Then, the read control unit 132 compares the read update time information pieces and determines whether a write failure has occurred in the data sector based on the comparison result.

FIG. 10 illustrates an example of read control at RAID 5. FIG. 10 represents a case of reading data from the data sector 211c (HDD #3:Sector #1) according to a read request from the host access control unit 120 after write processing of Data #1 and #2 is executed as illustrated in FIG. 9. In this case, first, the read control unit 132 reads contents stored in the sector 211c targeted for data reading and the parity sector 211e in the same stripe. Then, the read control unit 132 compares an update time information piece of the sector 211c, stored in the additional information area of the sector 211c, against an update time information piece of the sector 211c, stored in the additional information area of the sector 211e (S23). As illustrated in FIG. 10, the update time information pieces agree with each other, and the read control unit 132 therefore determines that no write failure occurred in the sectors 211c and 211e during the latest data write to the sector 211c.

Although no illustrative figure is given here, the read control unit 132 determines that a data write failure has occurred in the read-from data sector when the value of the update time information piece stored in the read-from data sector is smaller than that of the update time information piece stored in the parity sector of the same stripe. On the other hand, when the value of the update time information piece stored in the read-from data sector is larger than that of the update time information piece stored in the parity sector of the same stripe, the read control unit 132 determines that a parity write failure has occurred in the parity sector. The read control unit 132 requests the recovery control unit 150 for sector recovery while designating the sector determined to have undergone the write failure.

As described in FIGS. 9 and 10, in writing data to a RAID group with RAID 5, write-targeted data is written to the data areas of write-to data sectors. At the same time, an update time information piece of each write-to data sector and an update time information piece of a parity sector belonging to the same write-to stripe are written to the additional information area of the write-to data sector. In addition, parity calculated based on the data to be written is written to the data area of the parity sector. At the same time, update time information pieces of all the sectors making up the same stripe are written to the additional information area of the parity sector.

In reading data from a RAID group with RAID 5, update time information pieces of a read-from data sector are compared with each other after being individually read from the read-from data sector and a parity sector associated with the read-from data sector. Then, based on the comparison result, whether a write failure has occurred in the read-from data sector is determined. Allowing for such a determination of a write failure improves the reliability of data writing. In addition, by making the write failure determination in response to a data read request, it is possible to control the delay in a response to a data write request compared to the case of employing a RAW check.

With a data write, parity is also updated. In this regard, an update time information piece of a write-to data sector is written to an associated parity sector, which allows for a process of storing the update time information piece without little effect on the response time for a data write request. Further, in reading data, update time information pieces individually corresponding to the data and its parity are read from different HDDs in parallel. Thus, it is possible to read update time information pieces from a plurality of HDDs without any influence on the response time for a data read request.

Note that FIGS. 9 and 10 describe examples of determining whether a write failure has occurred in a sector belonging to a RAID group with RAID 5; however, the RAID level to which the above-described method is applied is not limited to RAID 5 and is applicable to a RAID group implementing redundancy using parity. For example, in FIGS. 9 and 10, the RAID level of RAID Group #2 may be RAID 3, RAID 4, or RAID 6. In the case of RAID 6, for example, the following update time information pieces are stored in the additional information area of each data sector: an update time information piece corresponding to the data sector; and update time information pieces each corresponding to a P-parity sector and a Q-parity sector in the same stripe. In addition, in the additional information area of each of the P-parity and Q-parity sectors, update time information pieces corresponding to all the data sectors in the same stripe as well as an update time information piece corresponding to its parity sector. In reading data, update time information pieces of the data are compared with each other after being individually read from its read-from data sector and one of the P- and Q-parity sectors, which allows for determining whether a data write failure has occurred.

Next described is data write control at RAID 5, involving read control of a different sector in the same stripe. This type of control takes place, for example, in a case where a write-to RAID group is configured at RAID and write control is exercised over only some data sectors amongst data sectors included in a write-to stripe. In this case, first, the write control unit 131 calculates parity. In this regard, in the case of updating not all data, but only a part of the data, in the write-to stripe, data needs to be read from one of sectors belonging to the stripe, other than write-to sectors, in order to calculate the parity.

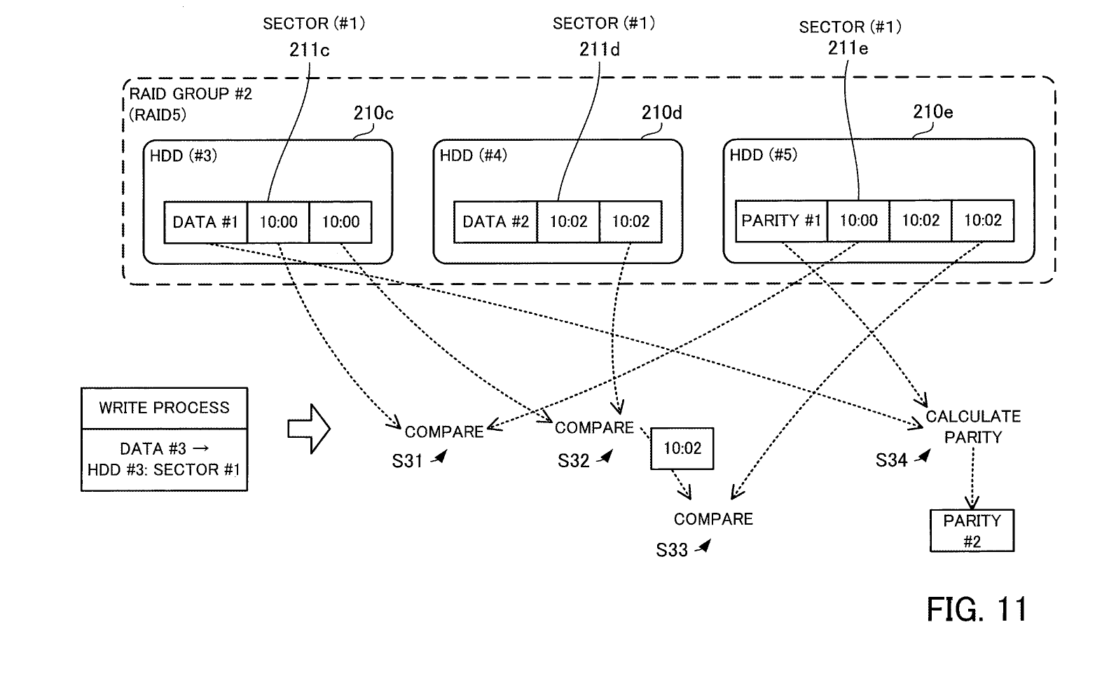

For example, the parity is calculated using a chain of “[pre-update data] XOR [post-update data] XOR [pre-update parity]”. In the case of employing this method, the read control unit 132 reads pre-update data from write-to sectors and also reads pre-update parity from a parity sector belonging to the same stripe as the write-to sectors in order to calculate the parity. At this time, the read control unit 132 determines whether a write failure has occurred in each of the read-from sectors. The details are described later in FIG. 11. After the read control unit 132 determines that no write failure has occurred in each of the sectors, the write control unit 131 calculates the parity based on the data read from the write-to sectors, the parity read from the parity sector, and write-targeted data.

Next, when writing the write-targeted data, the write control unit 131 generates an update time information piece of each of the write-to sectors. Then, the write control unit 131 simultaneously writes the generated update time information piece and the data to each write-to data sector. At the same time, the write control unit 131 simultaneously writes, to the parity sector, the calculated parity, the update time information pieces of the write-to data sectors, and the update time information of the parity sector. Subsequently, the write control unit 131 informs the host access control unit 120 of the write result.

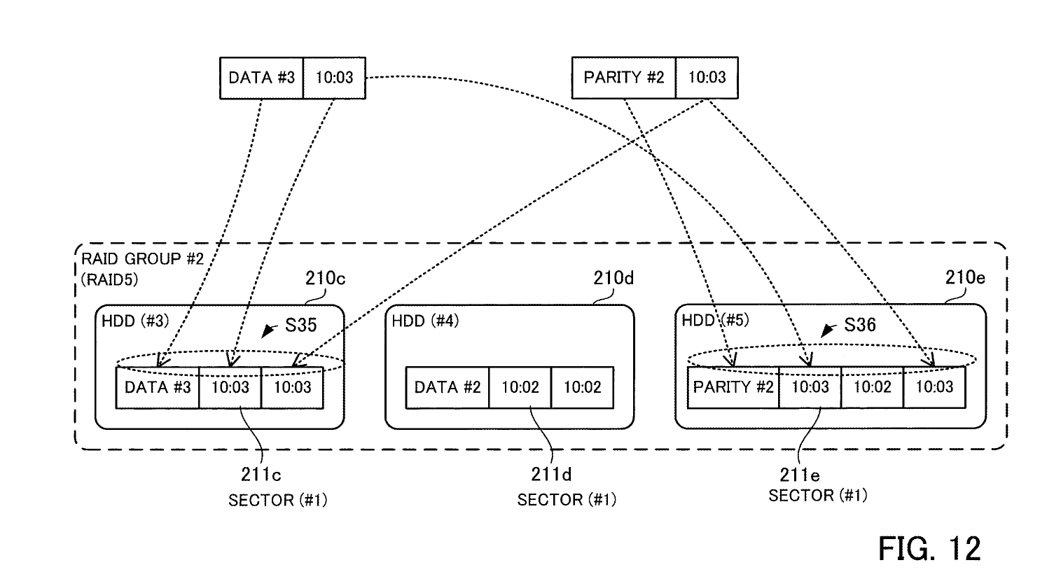

Next, a case of exercising write control over some data sectors amongst sectors included in a write-to stripe is described as an example of write control involving read control over a parity sector. FIG. 11 illustrates an example of data write control involving parity read control. In FIGS. 11 and 12, as for the same configurations and processes as in FIGS. 9 and 10, the descriptions are omitted. The data area of the sector 211c stores therein Data #1. The additional information area of the sector 211c stores therein an update time information piece “10:00” of the sector 211c and an update time information piece “10:00” of the parity sector (the sector 211e) updated at the time of writing Data #1, arranged in the stated order from the front side of the additional information area.

The data area of the sector 211d stores therein Data #2. The additional information area of the sector 211d stores therein an update time information piece “10:02” of the sector 211d and an update time information piece “10:02” of the parity sector (the sector 211e) updated at the time of writing Data #2, arranged in the stated order from the front side of the additional information area. The data area of the sector 211e stores therein Parity #1, which is parity of Data #1 and #2. The additional information area of the sector 211e stores therein the update time information piece “10:00” of the sector 211c, the update time information piece “10:02” of the sector 211d, and an update time information piece “10:02” of the parity sector 211e, arranged in the stated order from the front side of the additional information area.

Assume in this situation that the write control unit 131 carries out a process of writing Data #3 to Sector #1 in the HDD 210c belonging to RAID Group #2. First, in order to generate post-update parity, the read control unit 132 reads contents stored in the sector 211c including the pre-update Data #1 and the sector 211e including the pre-update parity. Next, the read control unit 132 compares the update time information piece of the sector 211c, stored in the additional information area of the sector 211c, against the update time information piece of the sector 211c, stored in the additional information area of the sector 211e (S31). As illustrated in FIG. 11, the update time information pieces agree with each other, and the read control unit 132 therefore determines that no write failure has occurred in the sector 211c. That is, the read control unit 132 determines that Data #1 stored in the sector 211c has been normally written.

In addition, the read control unit 132 reads content of the sector 211d. Then, the read control unit 132 compares the update time information piece of the parity sector, stored in the additional information area of the sector 211c, against that stored in the additional information area of the sector 211d. Note that the read control unit 132 is able to read from the sector 211d in parallel with reading from the sectors 211c and 211e.

The reason of comparing the update time information pieces of the parity sector read individually from the sectors 211c and 210d is that only one of the sectors 211c and 211d may have been updated prior to the state illustrated in FIG. 11. For example, when only the sector 211d is updated, the update time information piece of the parity sector stored in the sector 211d and that stored in the sector 211e are then updated. However, the update time information piece of the parity sector stored in the 211c is not updated. In this case, the update time information pieces of the parity sector stored in the sectors 211d and 211e do not agree with the update time information of the parity sector stored in the sector 211c. In case of such a situation, even when writing data to only some data sectors within the same stripe, the read control unit 132 reads update time information pieces of the parity sector from all data sectors in the stripe and compares them. Then, the read control unit 132 determines, amongst the read update time information pieces, an update time information piece having the largest value as the update time information piece of the parity sector obtained when the parity was updated most recently.

According to the example illustrated in FIG. 11, the update time information piece “10:02” of the parity sector, read from the sector 211d, has a larger value than the update time information piece “10:00” of the parity sector, read from the sector 211c. Therefore, the read control unit 132 determines that the update time information piece “10:02” of the parity sector, read from the sector 211d, is the update time information piece of the sector 211e obtained when the parity was updated most recently (S32). Then, the update time information piece “10:02” of the parity sector, read from the sector 211d, is used in the next comparison. That is, the read control unit 132 compares the update time information piece of the parity sector, read from the sector 211d, against that read from the sector 211e (S33). As illustrated in FIG. 11, these update time information pieces agree with each other. Therefore, the read control unit 132 determines that no write failure occurred during the latest parity write to the sector 211e. In other words, the read control unit 132 determines that Parity #1 stored in the sector 211e has been normally written. Next, the write control unit 131 calculates Parity #2 using a chain of “[Data #1] XOR [Data #3] XOR [Parity #1]” (S34). Data #1 is acquired from the data area of the sector 211c, and Parity #1 is acquired from the data area of the sector 211e.

FIG. 12 illustrates the example of data write control involving parity read control, continuing from FIG. 11. Next, the write control unit 131 generates an update time information piece “10:03” of each of the write-to data sector 211c and the write-to parity sector 211e. Then, the write control unit 131 updates the data area of the sector 211c with Data #3 while updating, within the additional information area of the sector 211c, the update time information pieces of both the sectors 211c and 211e with “10:03” (S35).

In addition, the write control unit 131 updates the data area of the sector 211e with Parity #2 while updating, within the additional information area of the sector 211e, the update time information pieces of both the sectors 211c and 211e with “10:03” (S36). Note that re-writing only a part of a sector is not allowed. Therefore, in the update in step S36, a write of an update time information piece of the sector 211d is also performed together with writes of Parity #2 and the update time information pieces “10:03” of the sectors 211c and 211e. The update time information piece of the sector 211d written in the additional information area of the sector 211e at this point is the previous update time information piece “10:02”. Note that, since the storage system 2 supports parallel access to HDDs in the disk array 200, steps S35 and S36 may be carried out in parallel. This improves write speed.

As described in FIGS. 11 and 12, a read process may take place even when a write request is made by the host access control unit 120. In such a case also, the read control unit 132 determines whether a write failure has occurred by comparing update time information pieces.

In performing a read process for a parity sector, an update time information piece having the largest value is identified amongst update time information pieces of the parity sector, stored in individual data sectors, and the identified update time information piece is compared with an update time information piece of the parity sector, stored in the parity sector. This allows for correct determination of whether a write failure has occurred in the parity sector.

Note that according to the second embodiment, the read control unit 132 calculates post-update parity based on post-update data, pre-update data, and pre-update parity. Alternatively, the post-update parity may be calculated based on data stored in all data sectors making up the write-to stripe, except for the write-to sectors, and the post-update data. In this case, contents of each of the data sectors other than the write-to sectors are read to determine whether a write failure has occurred in the data sector, using the method described in FIG. 10.

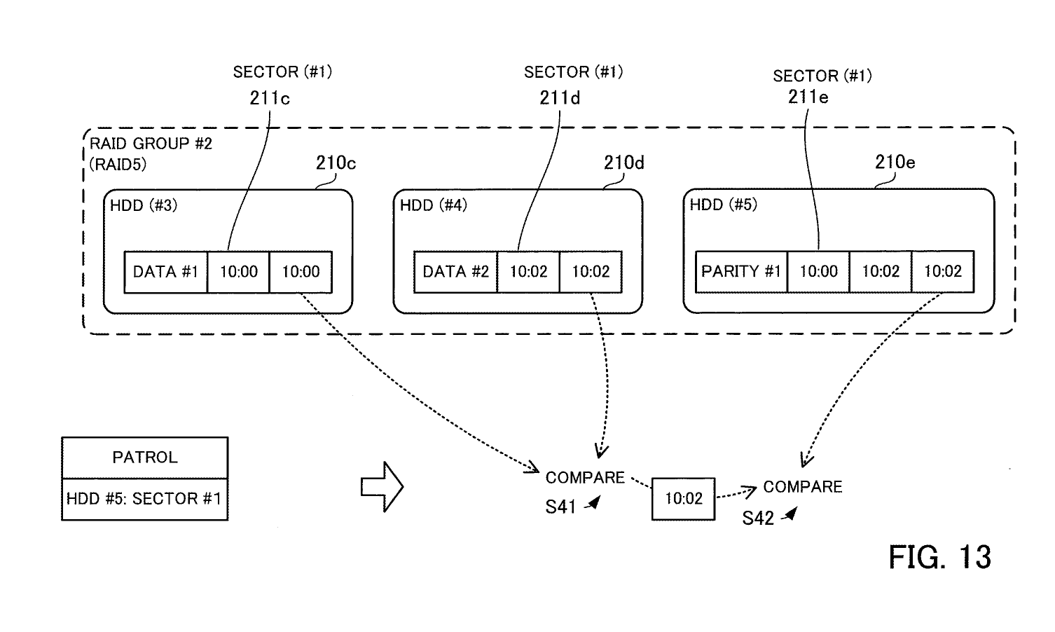

Next, a case where parity is read from a parity sector in a patrol read is described with reference to FIG. 13. FIG. 13 illustrates an example of parity read control at RAID 5. In FIG. 13, as for the same configurations and processes as in FIGS. 9 to 12, the descriptions are omitted. The same contents as in FIG. 11 are stored in the data area and the additional information area of each of the sectors 211c, 211d, and 211e. Assume here that the patrol control unit 140 reads the contents of Sector #1 of HDD #5. In this case, the patrol control unit 140 first reads the contents of the sectors 211c, 211d, and 211e. Then, the patrol control unit 140 compares an update time information piece of the parity sector, stored in the additional information area of the sector 211c, against that stored in the additional information area of the sector 211d. As illustrated in FIG. 13, between these update time information pieces, one stored in the sector 211d has a larger value than one stored in the sector 211c. Therefore, the patrol control unit 140 determines that the update time information piece of the parity sector, stored in the sector 211d, is the update time information piece of the sector 211e obtained when the parity was updated most recently (S41).

Next, the patrol control unit 140 compares the update time information piece determined to be the update time information piece obtained during the latest parity update against the update time information piece of the sector 211e, stored in the sector 211e (S42). As illustrated in FIG. 13, these update time information pieces agree with each other. Therefore, the patrol control unit 140 determines that no write failure occurred in the sectors 211d and 211e during the latest parity write to the sector 211e.

Although no illustrative figure is given here, if the update time information piece of the parity sector has a smaller value than the compared update time information piece of the parity sector, stored in a data sector, the patrol control unit 140 determines that a write failure has occurred in the parity sector. On the other hand, if the update time information piece of the parity sector has a larger value than the compared update time information piece of the parity sector, stored in a data sector, the patrol control unit 140 determines that a write failure has occurred in one of data sectors. In the latter case, the patrol control unit 140 determines whether a write failure has occurred with respect to each of the data sectors using the method described in FIG. 10, to thereby determine a data sector with the write failure. The patrol control unit 140 requests the recovery control unit 150 for sector recovery while designating the sector determined to have undergone the write failure.

As illustrated in FIG. 13, a patrol read of a parity sector involves a read of the parity sector. In such a case also, the patrol control unit 140 compares update time information pieces to thereby determine whether a write failure has occurred.

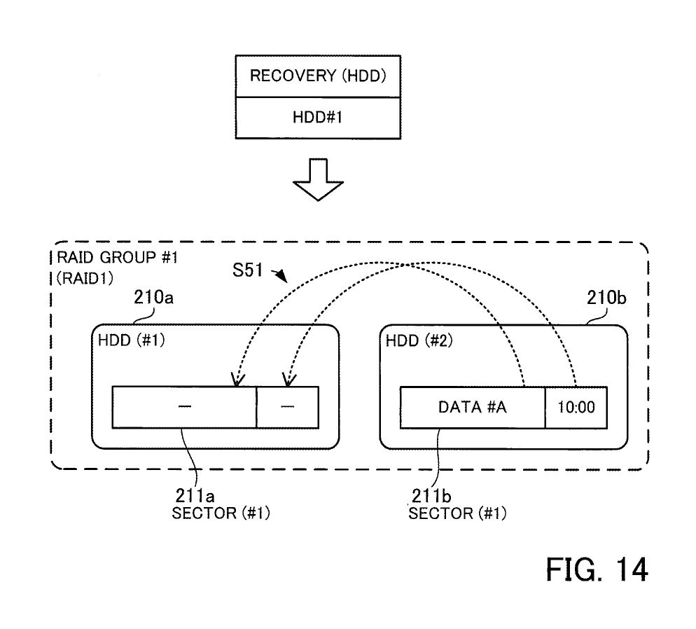

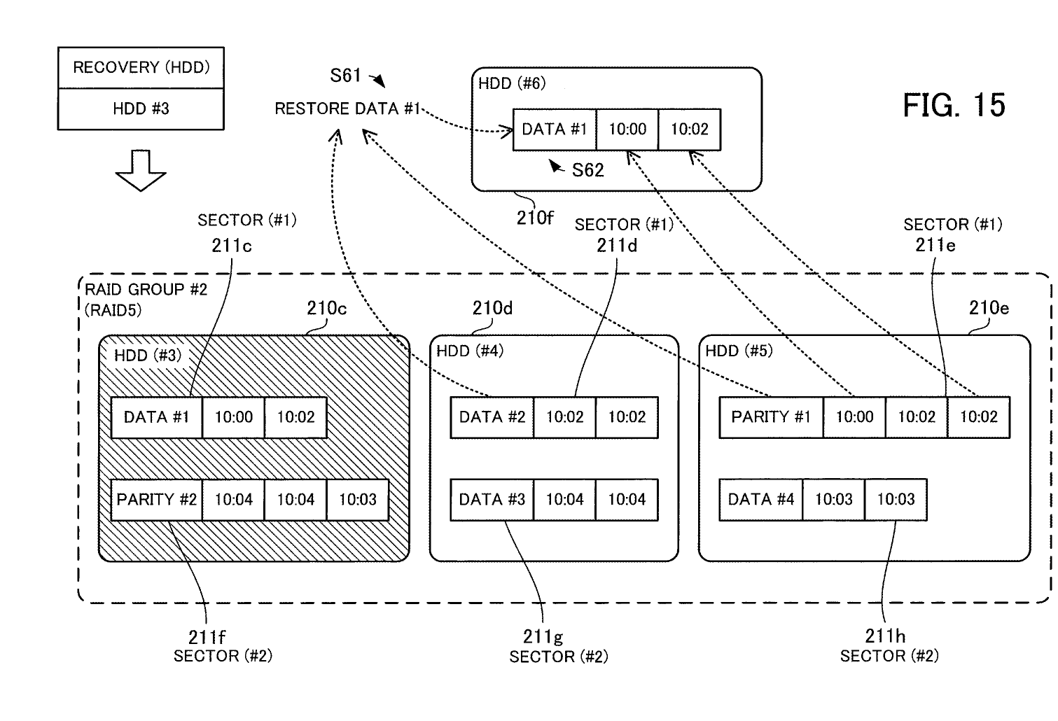

Next, an example of recovering a HDD is described using FIGS. 14 to 17. First, recovery of a HDD belonging to a RAID group with RAID 1 is described with reference to FIG. 14. Then, recovery of a HDD belonging to a RAID group with RAID 5 is described with reference to FIGS. 15 to 17. FIG. 14 illustrates an example of recovery of a HDD belonging to a RAID group with RAID 1. In FIG. 14, as for the same configurations and processes as in FIG. 7, the descriptions are omitted. In the sector 211b, the data area stores Data #A and the additional information area stores the update time information piece “10:00” of the sector 211b. The HDD 210a is used as a replacement of a HDD (not illustrated) having operated with the HDD 210b in pairs, for example, when the paired HDD fails, and no data is stored in each sector (for example, the sector 211a) of the HDD 210a.

Recovery of the HDD 210a taking place in this situation is described here using the sectors 211a and 211b. The recovery control unit 150 copies the contents of the data area of the sector 211b to the data area of the sector 211a. In addition, the recovery control unit 150 copies, not a newly generated update time information piece, but the update time information piece stored in the additional information area of the sector 211b to the additional information area of the sector 211a (S51). That is, in recovering a HDD belonging to a RAID group with RAID 1, the contents on the mirrored disk of a recovery-target HDD are directly copied.

Note that if a newly generated update time information piece is written in the recovery, a mismatch occurs in a comparison using the update time information piece, involved in a subsequent read process. This, therefore, interrupts a proper determination regarding a write failure to be made by comparing update time information pieces after recovery. On the other hand, the above-described process allows a proper write failure determination based on the comparison result of update time information pieces even in a read process after recovery.

FIG. 15 illustrates an example of recovery of a HDD belonging to a RAID group with RAID 5. In FIGS. 15 to 17, as for the same configurations and processes as in FIGS. 9 to 12, the descriptions are omitted. The HDD 210f is a spare HDD called “hot spare”. The disk number of the hot-spare HDD 210f is “#6”. The sector 211c of the HDD 210c, the sector 211d of the HDD 210d, and the sector 211e of the HDD 210e make up a single stripe. The sector number of the individual sectors 211c, 211d, and 211e is #1. The sectors 211c and 211d are data sectors while the sector 211e is a parity sector. The sectors 211c and 211d store Data #1 and Data #2, respectively, in their data areas, and the sector 211e stores Parity #1 in its data area. Similarly, a sector 211f of the HDD 210c, a sector 211g of the HDD 210d, and a sector 211h of the HDD 210e make up a single stripe. The sector number of the individual sectors 211f, 211g, and 211h is #2. The sectors 211g and 211h are data sectors while the sector 211f is a parity sector. The sectors 211g and 211h store Data #3 and Data #4, respectively, in their data areas, and the sector 211f stores Parity #2 in its data area.

A recovery process taking place in the above-described situation when the HDD 210c has failed is described here using the sectors 211c to 211h. First, the recovery control unit 150 reads the contents of the sectors 211d and 211e with the sector number #1. Then, the recovery control unit 150 restores Data #1 having been stored in the sector 211c by taking an exclusive OR (XOR) of Data #2 stored in the sector 211d and Parity #1 stored in the sector 211e (S61). Next, the recovery control unit 150 writes the restored Data #1 to the data area of Sector #1 of the hot-spare HDD 210f. At the same time, the recovery control unit 150 writes the update time information piece “10:00” of the sector 211c and the update time information piece “10:02” of the sector 211e to the additional information area of Sector #1 of the HDD 210f in the stated order (S62). The update time information pieces of the sectors 211c and 211e are stored in the additional information area of the sector 211e.

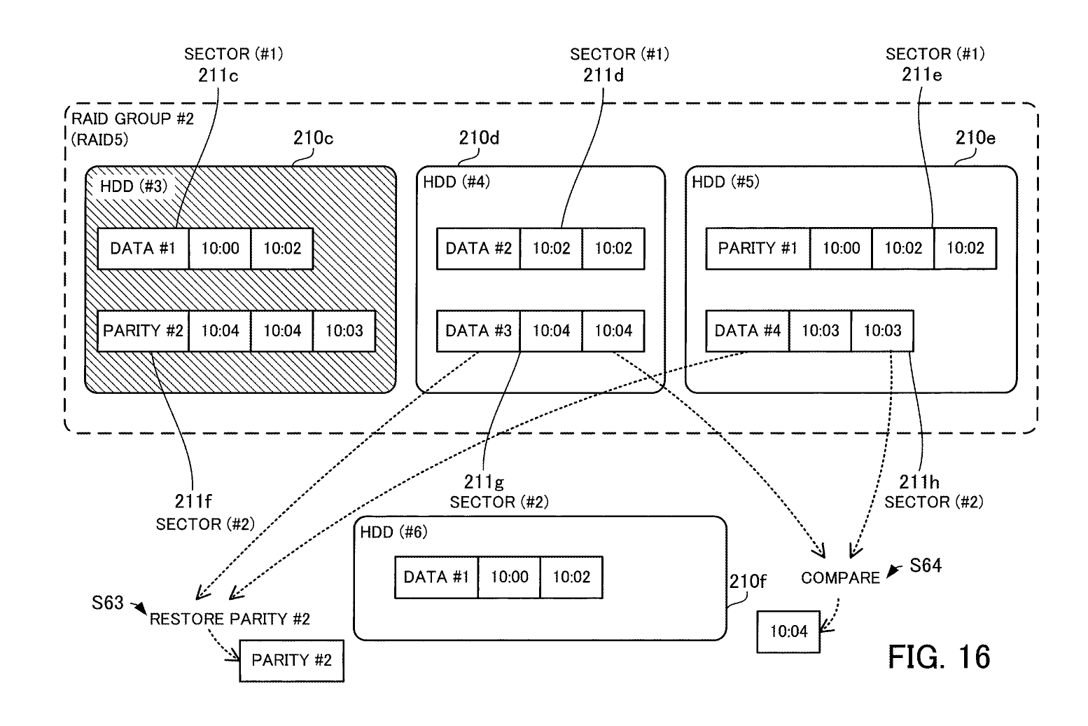

FIG. 16 illustrates the example of recovery of a HDD belonging to a RAID group with RAID 5, continuing from FIG. 15. FIG. 16 represents a process of restoring parity having been stored in the sector 211f. The process of restoring parity is partially different from the process of restoring data illustrated in FIG. 15. The recovery control unit 150 reads the contents of the sectors 211g and 211h with the sector number #2. The recovery control unit 150 restores Parity #2 having been stored in the sector 211f by taking an exclusive OR (XOR) of Data #3 stored in the sector 211g and Data #4 stored in the sector 211h (S63).

Next, the recovery control unit 150 compares the update time information piece of the parity sector, stored in the sector 211g, against that stored in the sector 211h. The recovery control unit 150 identifies, between these update time information pieces stored in the individual data sectors, one having a larger value as the update time information piece of the sector 211f (i.e., the parity sector), having been stored in the sector 211f (S64). As illustrated in FIG. 16, the update time information piece “10:04” of the parity sector, stored in the sector 211g has a larger value than the update time information piece “10:03” of the parity sector, stored in the sector 211h. Therefore, the update time information piece “10:04” is identified as the update time information piece having been stored in the sector 211f.

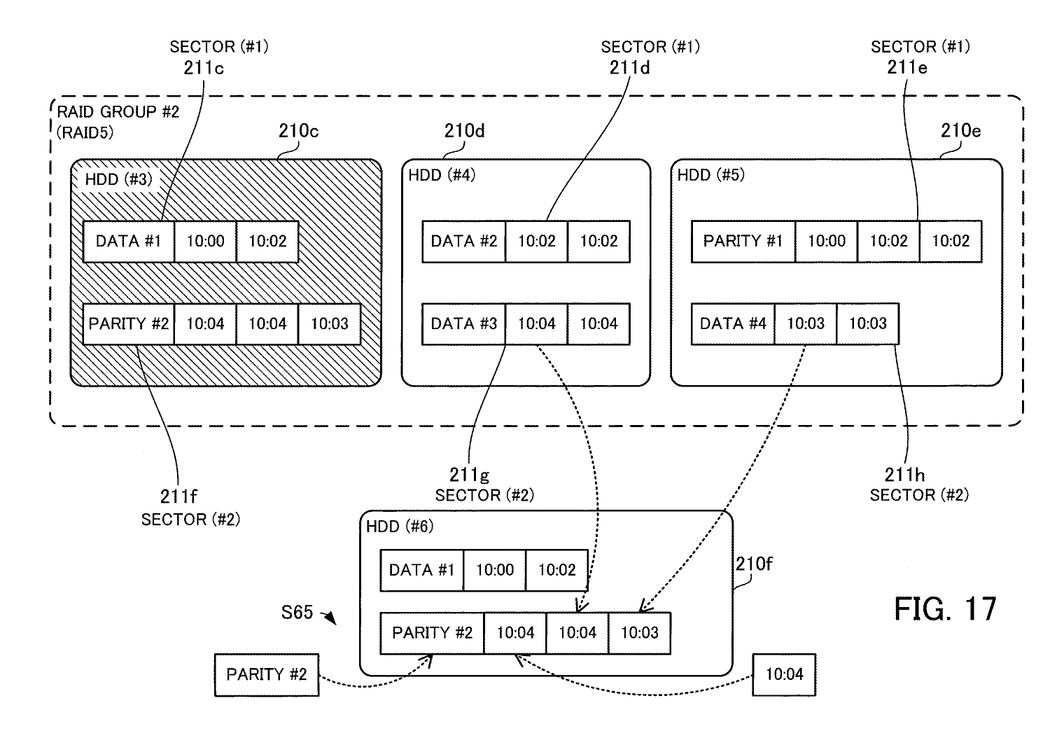

FIG. 17 illustrates the example of recovery of a HDD belonging to a RAID group with RAID 5, continuing from FIG. 16. Next, the recovery control unit 150 writes the restored Parity #2 to the data area of Sector #2 of the hot-spare HDD 210f. At the same time, the recovery control unit 150 writes the update time information piece “10:04” of the sector 211f, the update time information piece “10:04” of the sector 211g, and the update time information piece “10:03” of the sector 211h to the additional information area of Sector #2 of the HDD 210f in the stated order (S65). The update time information pieces of the sectors 211g and 211h are stored in the additional information areas of the sectors 211g and 211h, respectively. Thus, the recovery control unit 150 restores the contents of each sector in the HDD 210c, and stores the restored sector contents in a sector of the hot-spare HDD 210f, having the same sector number as the sector in the HDD 210c.

The method described in FIGS. 15 to 17 allows a proper determination regarding a write failure to be made based on a comparison result of update time information pieces in a read process after the recovery HDD 210f is incorporated in RAID Group #2. Note that subsequently when a new HDD (not illustrated) is installed in place of the failed HDD 210c, the recovery control unit 150 writes the contents of the hot-spare HDD 210f back to the new HDD. At this time, the recovery control unit 150 directly copies the contents of the data area and the additional information area of each sector in the hot-spare HDD 210f to the corresponding sector in the new HDD, as in the process illustrated in FIG. 14. This allows a proper determination regarding a write failure to be made based on a comparison result of update time information pieces in a read process after the HDD for which the write-back is completed is incorporated in the RAID group.

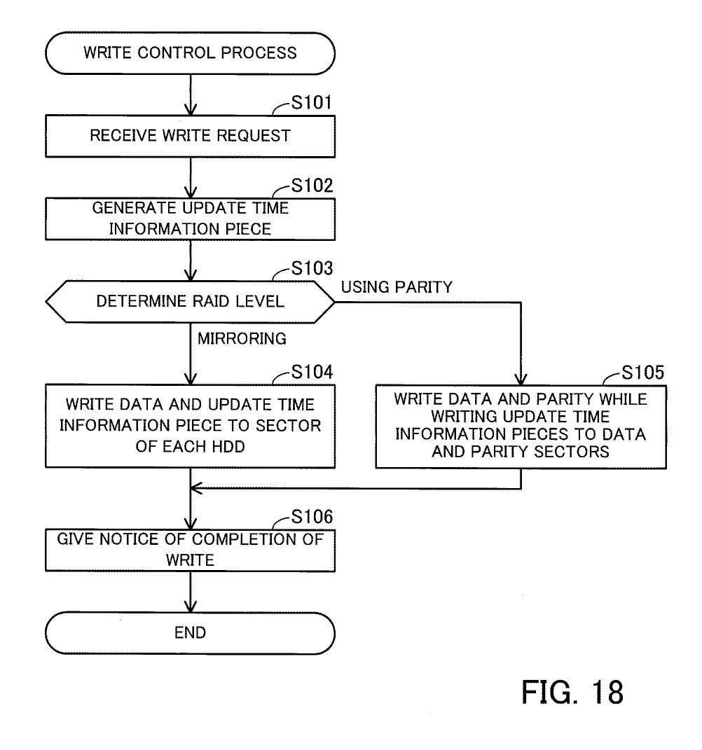

Next described are write and read control processes with reference to flowcharts of FIGS. 18 to 20. FIG. 18 is a flowchart illustrating an example of a write control process. The process of FIG. 18 is described next according to the step numbers in the flowchart.

(S101) The write control unit 131 receives a data write request from the host access control unit 120. Note that the host access control unit 120 outputs a data write request, for example, in order to allow “write-back” to take place, in which data stored in the cache area is written to HDDs within the disk array 200. Specific examples of write-back implementation include a case of writing data with the earliest final update time to HDDs when the remaining capacity of the cache area has reached a predetermined limit or less and then deleting the data from the cache area, and a case of writing, after a predetermined period has elapsed since an update of data in the cache area, the updated data to HDDs.

The write request issued from the host access control unit 120 includes, for example, a first logical address of a logical volume for the write-targeted data. The write control unit 131 identifies a RAID group corresponding to the logical volume. Then, referring to the RAID management table 111 corresponding to the identified RAID group, the write control unit 131 identifies a write-to sector based on information on the RAID group, the first logical address designated by the host access control unit 120, and the data length of the data to be written. The write-to sector is designated by a combination of a disk number and a sector number.

(S102) The write control unit 131 generates an update time information piece. The generated update time information piece indicates the current time and date.

(S103) Referring to the RAID management table 111, the write control unit 131 determines a RAID level of the write-targeted RAID group. If it is a RAID level with mirroring (for example, RAID 1), the process proceeds to step S104. If it is a RAID level using parity (for example, RAID 5), the process proceeds to step S105.

(S104) When writing data of one sector to each of two write-to HDDs in parallel, the write control unit 131 writes the update time information piece generated in step S102 to the sector of each HDD together with the data. This process is as described in step S11 of FIG. 7.

(S105) The write control unit 131 updates each write-to data sector and a parity sector within a single stripe.

In the case where all data sectors in the stripe are targeted for data write, a write process is performed according to the procedure described in steps S21 and S22 of FIG. 9. In this case, the write control unit 131 writes new data or parity in the data areas of all the sectors in the stripe. At the same time, the write control unit 131 writes the update time information piece generated in step S102 to the additional information areas of all the sectors in the stripe.

In the case where only some of the data sectors in the stripe are targeted for data write, a write process is performed according to the procedure illustrated in FIGS. 11 and 12. In this case, the write control unit 131 writes new data and its update time information piece to the data area and additional information area, respectively, of each of the write-to data sectors within the stripe. In addition, the write control unit 131 writes new parity in the data area of the parity sector, and also writes, to the additional information area of the parity sector, update time information pieces of the write-to data sectors and an update time information piece of the parity sector.

(S106) The write control unit 131 responds to the host access control unit 120 by giving notice of completion of the write process performed in response to the write request from the host access control unit 120.

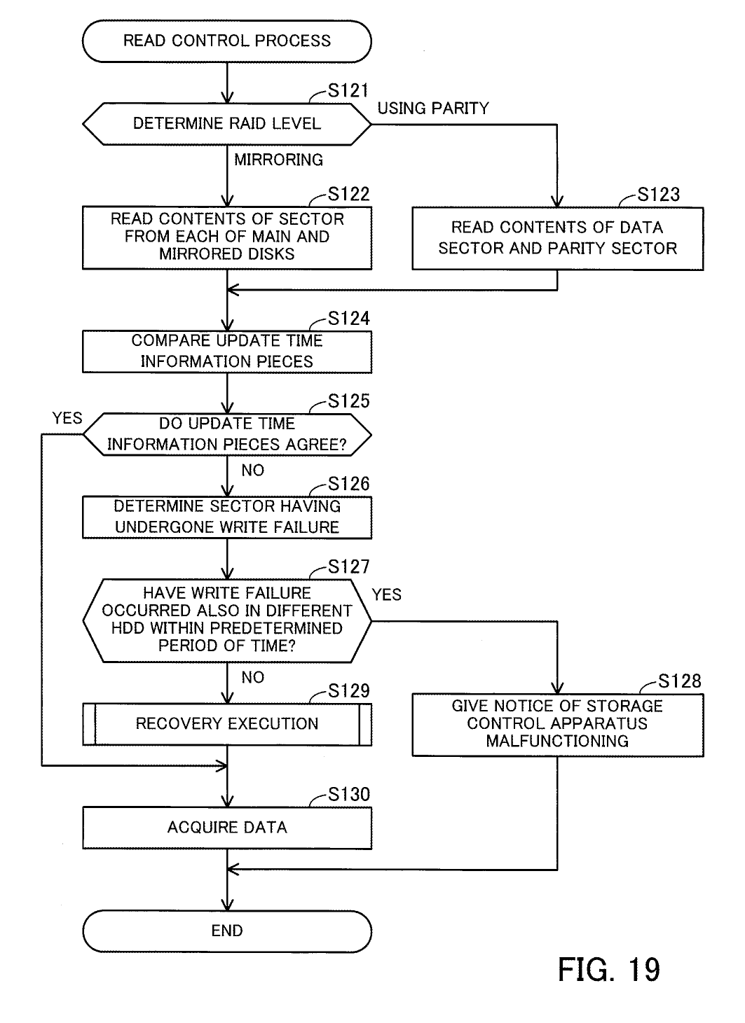

FIG. 19 is a flowchart illustrating an example of a read control process. The read control unit 132 receives designation of read-targeted logical volume and logical address from the host access control unit 120. Referring to the RAID management table 111 corresponding to the designated logical volume, the read control unit 132 identifies read-from disk number and sector number. Then, the read control unit 132 carries out the process of FIG. 19 for each read-from sector. The process of FIG. 19 is described next according to the step numbers in the flowchart.

(S121) Referring to the RAID management table 111, the read control unit 132 determines the RAID level of a read-from RAID group. If it is a RAID level with mirroring, the process proceeds to step S122. If it is a RAID level using parity, the process proceeds to step S123.

(S122) The read control unit 132 reads contents of the sector in a main disk (a main HDD between duplicated HDDs), and also reads contents of the sector in a mirrored disk (the other HDD of the duplicated HDDs).

(S123) The read control unit 132 reads contents of the data sector, and also reads contents of a parity sector in the same stripe.

Note that in the case of handling a plurality of read-from data sectors in the same stripe, reads from the data sectors and the parity sector are carried out simultaneously.

(S124) The read control unit 132 acquires update time information pieces of the read-from data sector from the additional information areas of the individual sectors, and then compares the acquired update time information pieces.

(S125) The read control unit 132 determines whether the update time information pieces acquired in step S124 agree with each other. If the update time information pieces agree with each other, the process proceeds to step S130. If the update time information pieces do not agree with each other, the process proceeds to step S126.

(S126) Based on the comparison result of the update time information pieces in steps S124 and S125, the read control unit 132 determines which one of the sectors with the compared update time information pieces has undergone a write failure.

(S127) The read control unit 132 determines whether, during a predetermined period (for example, ten minutes) leading up to this point in time, the occurrence of a write failure has been determined also in a different HDD amongst HDDs installed in the disk array 200, except for the HDD to which the sector determined in step S126 to have undergone a write failure belongs. If a write failure has occurred also in a different HDD, the process proceeds to step S128. If no write failure has occurred in a different HDD, the process proceeds to step S129.

(S128) The read control unit 132 informs the administrator of the storage system 2 of the storage control apparatus 100 malfunctioning.

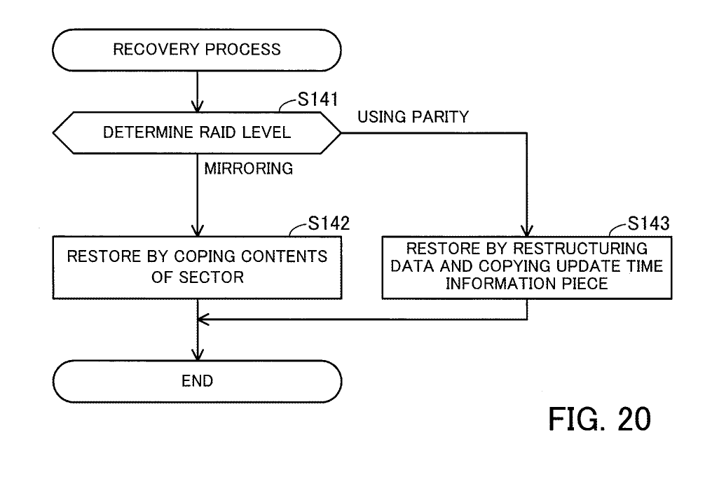

(S129) The read control unit 132 requests the recovery control unit 150 for sector recovery while designating the sector determined in step S126 to have undergone a write failure. In response to the request from the read control unit 132, the recovery control unit 150 recovers the designated sector. The details are described later in FIG. 20.

(S130) The read control unit 132 acquires data requested to be read. In the case where step S122 has been executed, the data is acquired from the data area of the data sector in the main disk. In the case where step S123 has been executed, the data is acquired from the data area of the data sector. The read control unit 132 temporarily stores the acquired data, for example, in the RAM 102.

FIG. 20 is a flowchart illustrating an example of a recovery process. The process of FIG. 20 is executed in the above-described step S129. In executing this process, sectors to be recovered are designated. Each of the recovery-targeted sectors is designated by a combination of a disk number and a sector number. The process of FIG. 20 is described next according to the step numbers in the flowchart.

(S141) Referring to the RAID management table 111, the recovery control unit 150 determines the RAID level of a recovery-target RAID group. If it is a RAID level with mirroring, the process proceeds to step S142. If it is a RAID level using parity, the process proceeds to step S143.

(S142) The recovery control unit 150 copies contents in the data area and the additional information area of the acquisition-source sector associated with an update time information piece indicating a later time and date between the update time information pieces compared in step S124 to the data area and the additional information area, respectively, of the other sector. Herewith, the contents of the sector having undergone a write failure are restored.

(S143) The recovery control unit 150 restores the contents of the sector in the following manner. In the case where, in step S126, a write failure is determined to have occurred in the data sector, the recovery control unit 150 reads contents of all data sectors, except for the data sector with the write failure, and the parity sector within the same stripe. The recovery control unit 150 calculates data of the data area in the data sector with the write failure based on data of the individual data areas and parity included in the read contents. At the same time, the recovery control unit 150 acquires, from the additional information area of the parity sector, an update time information piece of the data sector with the write failure and an update time information piece of the parity sector. The recovery control unit 150 writes the calculated data to the data area of the data sector with the write failure, and also writes the acquired update time information pieces in the additional information area of the data sector. Herewith, the contents of the data sector with the write failure are restored.

Referring to FIG. 15 where a write failure has occurred in the sector 211c, note that the above-described process corresponds to a process of writing the restored Data #1 and the update time information pieces, not to the host-spare sector as illustrated in FIG. 15, but to the original sector 211c.

On the other hand, in the case where, in step S126, a write failure is determined to have occurred in the parity sector, the recovery control unit 150 reads contents of all the data sectors of the stripe. The recovery control unit 150 recalculates parity based on data of the individual data areas included in the read contents. At the same time, the recovery control unit 150 compares update time information pieces of the parity sector, stored in the individual additional information areas included in the read contents, and then selects an update time information piece indicating the latest time and date. The recovery control unit 150 writes the recalculated parity to the data area in the parity sector with the write failure. At the same time, the recovery control unit 150 writes, to the additional information area of the parity sector with the write failure, update time information pieces of the individual data sectors, stored in the additional information areas of the individual data sectors, and the update time information piece of the parity sector, selected according to the above-described procedure. Herewith, the contents of the parity sector with the write failure are restored.

Referring to FIGS. 16 and 17 where a write failure has occurred in the sector 211f, note that the above-described process corresponds to a process of writing the restored Parity #2 and the update time information pieces, not to the host-spare sector as illustrated in FIG. 17, but to the original sector 211f.

According to the processes of FIGS. 19 and 20, when the update time information pieces do not agree with each other in step S125, the read control unit 132 compares the update time information pieces to thereby determine in step S126 which one of sectors individually associated with the compared update time information pieces has undergone a write failure. As a result, the read control unit 132 is able to request the recovery control unit 150 for sector recovery while designating the sector determined to have undergone a write failure as a recovery target. Herewith, the contents of the sector with the write failure are updated to valid contents, which enhances the reliability of recorded data.

Note that the information processing of the first embodiment is implemented by causing the storage control apparatus 10 to execute a program, as described above. In addition, the information processing of the second embodiment is implemented by causing the storage control apparatus 100 to execute a program. Such a program may be recorded in a computer-readable storage medium (for example, the storage medium 106a). Examples of such a computer-readable storage medium include a magnetic disk, an optical disk, a magneto-optical disk, and a semiconductor memory. Examples of the magnetic disk are a flexible disk (FD) and a HDD. Examples of the optical disk are a compact disc (CD), CD-recordable (CD-R), CD-rewritable (CD-RW), DVD, DVD-R, and DVD-RW.

To distribute the program, for example, portable storage media on which the program is recorded are provided. In addition, the program may be stored in a storage device of a different computer and then distributed via a network. A computer for executing the program stores, for example, in a storage device (for example, the HDD 103), the program which is originally recorded on a portable storage medium or received from the different computer, and then executes the program by loading it from the storage device. Note however that the computer may directly execute the program loaded from the portable storage medium or received from the different computer via the network. In addition, at least part of the above-described information processing may be achieved by an electronic circuit, such as a digital signal processor (DSP) and a programmable logic device (PLD).

According to one aspect, it is possible to provide a storage control apparatus, a storage control method, and a storage control program, which ensure high reliability of writing while controlling a delay in a response to a write request.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A storage control apparatus comprising:
a processor that performs a procedure including:
writing, in response to a write request for write data, the write data to a first memory device with addition of an additional data piece to be updated with each write to the same storage area while writing the additional data piece, within a second memory device, to a storage area corresponding to the write data, and outputting a completion notice of the writing carried out according to the write request;
reading, in response to a read request for read data, the read data and an additional data piece added to the read data from the first memory device while reading an additional data piece, within the second memory device, from a storage area corresponding to the read data; and
checking the additional data pieces individually read from the first and the second memory devices and determining validity of the read data based on a checked result.

2. The storage control apparatus according to claim 1, wherein:
the writing includes writing redundant data corresponding to the write data to the second memory device with addition of the additional data piece added to the write data written to the first memory device; and
the reading carried out according to the read request includes reading the read data and the additional data piece added to the read data from the first memory device while reading the additional data piece added to the redundant data from the second memory device.

3. The storage control apparatus according to claim 2, wherein:
the writing includes including a time information piece in each of the additional data pieces individually added to the write data and the redundant data, the time information piece indicating a time of writing of the write data; and
the checking includes comparing the time information pieces included in the additional data pieces, and determining, when the time information pieces agree with each other, both the read data and the redundant data as valid and determining, when the time information pieces disagree with each other, one of the read data and the redundant data whose added additional data piece includes the time information piece indicating an earlier time as invalid.

4. The storage control apparatus according to claim 3, wherein:
the procedure further includes restoring, when one of the read data and the redundant data is determined as invalid, the one determined as invalid using the other, and updating the one stored in either the first memory device or the second memory device and the additional data piece added to the one with the restored one and the additional data piece added to the other, respectively.

5. The storage control apparatus according to claim 2, wherein:
the procedure further includes writing, when restoring data stored in the first memory device using the redundant data corresponding to the data, stored in the second memory device, and then storing the restored data in a third memory device, the restored data to the third memory device with addition of the additional information piece added to the redundant data, stored in the second memory device.

6. The storage control apparatus according to claim 2, wherein:
the writing includes writing parity data calculated using the write data to the second memory device as the redundant data.

7. The storage control apparatus according to claim 6, wherein:
unit storage areas each provided in one of a plurality of memory devices including the first and the second memory devices make up a stripe;
two or more predetermined number of the unit storage areas are allocated as data storage areas for storing the write data, and a remaining unit storage area is allocated as a parity storage area for storing the parity data calculated based on the write data stored in the data storage areas; and
the procedure further includes
adding, when the parity data stored in the parity storage area is updated with an update of data stored in one or more of the data storage areas, a parity update time information piece indicating an update time of the parity data to the updated parity data stored in the parity storage area, and adding the added parity update time information piece also to the updated data stored in the one or more data storage areas, and
checking, when the parity data is read from the parity storage area, the parity update time information piece added to the read parity data and, amongst parity update time information pieces added to data in all the data storage areas within the stripe, a parity update time information piece indicating a latest time to thereby determine validity of the read parity data.

8. The storage control apparatus according to claim 2, wherein:
the writing includes writing the same data as the write data to the second memory device as the redundant data.

9. A storage control method comprising:
writing, by a storage control apparatus, in response to a write request for write data, the write data to a first memory device with addition of an additional data piece to be updated with each write to the same storage area while writing the additional data piece, within a second memory device, to a storage area corresponding to the write data, and outputting a completion notice of the writing carried out according to the write request;
reading, by the storage control apparatus, in response to a read request for read data, the read data and an additional data piece added to the read data from the first memory device while reading an additional data piece, within the second memory device, from a storage area corresponding to the read data; and
checking, by the storage control apparatus, the additional data pieces individually read from the first and the second memory devices and determining validity of the read data based on a checked result.

10. The storage control method according to claim 9, wherein:
the writing includes writing redundant data corresponding to the write data to the second memory device with addition of the additional data piece added to the write data written to the first memory device; and
the reading carried out according to the read request includes reading the read data and the additional data piece added to the read data from the first memory device while reading the additional data piece added to the redundant data from the second memory device.

11. The storage control method according to claim 10, wherein:
the writing includes including a time information piece in each of the additional data pieces individually added to the write data and the redundant data, the time information piece indicating a time of writing of the write data; and
the checking includes comparing the time information pieces included in the additional data pieces, and determining, when the time information pieces agree with each other, both the read data and the redundant data as valid and determining, when the time information pieces disagree with each other, one of the read data and the redundant data whose added additional data piece includes the time information piece indicating an earlier time as invalid.

12. The storage control method according to claim 11, further comprising:
restoring, when one of the read data and the redundant data is determined as invalid, the one determined as invalid using the other, and updating the one stored in either the first memory device or the second memory device and the additional data piece added to the one with the restored one and the additional data piece added to the other, respectively.

13. The storage control method according to claim 10, further comprising:
writing, when restoring data stored in the first memory device using the redundant data corresponding to the data, stored in the second memory device, and then storing the restored data in a third memory device, the restored data to the third memory device with addition of the additional information piece added to the redundant data, stored in the second memory device.

14. The storage control method according to claim 10, wherein:
the writing includes writing parity data calculated using the write data to the second memory device as the redundant data.

15. A non-transitory computer-readable storage medium storing a computer program that causes a computer to perform a procedure comprising:
writing, in response to a write request for write data, the write data to a first memory device with addition of an additional data piece to be updated with each write to the same storage area while writing the additional data piece, within a second memory device, to a storage area corresponding to the write data, and outputting a completion notice of the writing carried out according to the write request;
reading, in response to a read request for read data, the read data and an additional data piece added to the read data from the first memory device while reading an additional data piece, within the second memory device, from a storage area corresponding to the read data; and
checking the additional data pieces individually read from the first and the second memory devices and determining validity of the read data based on a checked result.
